(19) United States
(12) Patent Application Publication
(10) Pub. No.: US 2010/0002569 A1
(43) Pub. Date: Jan. 7, 2010

(54) OPTICAL INFORMATION RECORDING MEDIUM, METHOD OF RECORDING AND REPRODUCING INFORMATION, AND AZO METAL COMPLEX DYE

(75) Inventors: Hisato NAGASE, Kanagawa (JP); Tetsuya Watanabe, Kanagawa (JP); Taro Hashizume, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/491,366

(22) Filed: Jun. 25, 2009

(30) Foreign Application Priority Data
Jul. 1, 2008 (JP) 2008-172023

(51) Int. Cl. G11B 7/24; C09B 45/14; C09B 45/18; C09B 45/20; G11B 7/246

(52) U.S. Cl. 369/275.4; 534/710; 534/705; 428/64.8; G9B/7.139

(57) ABSTRACT

An aspect of the present invention relates to an optical information recording medium comprising a recording layer on a surface of a support, wherein the surface of the support has pregrooves with a track pitch ranging from 50 to 500 nm, the recording layer comprises an azo metal complex dye in the form of a complex of at least one azo dye denoted by general formula (1) and at least one metal ion:

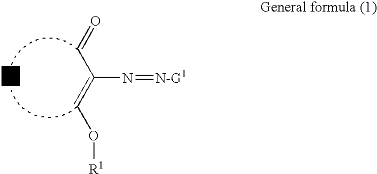

wherein, in general formula (1), Q¹ denotes an atom group forming a ring with two adjacent carbon atoms and a carbon atom bonded to —N═N-group, G¹ denotes a heterocyclic group or carbocyclic group, and R¹ denotes an alkyl group, alkenyl group, alkynyl group, aryl group, or heterocyclic group.

### CROSS-REFERENCE TO RELATED APPLICATIONS

This application claims the benefit of priority under 35 USC 119 to Japanese Patent Application No. 2008-172023 filed on Jul. 1, 2008, which is expressly incorporated herein by reference in its entirety.

### BACKGROUND OF THE INVENTION

1. Field of the Invention

The present invention relates to an optical information recording medium permitting the recording and reproducing of information with a laser beam, and more particularly, to a heat mode optical information recording medium suited to the recording and reproducing of information with a short-wavelength laser beam with a wavelength of equal to or shorter than 440 nm and to a method of recording and reproducing information on the optical information recording medium by irradiation of a short-wavelength laser beam with a wavelength of equal to or shorter than 440 nm.

The present invention further relates to a novel azo metal complex dye suitable for use as a dye in the recording layer of an optical information recording medium.

2. Discussion of the Background

Networks, such as the Internet, and high-definition television have recently achieved widespread popularity. With high-definition television (HDTV) broadcasts near at hand, demand is growing for high-capacity recording media for recording image information both economically and conveniently. However, the CD-R (recordable CD) and DVD-R (recordable DVD) do not afford recording capacities that are adequate to handle future needs. Accordingly, to increase the recording density by using a laser beam of even shorter wavelength than that employed in a DVD-R, the development of high-capacity disks capable of recording with laser beams of short wavelength (for example, equal to or shorter than 440 nm) is progressing. For example, optical recording disks with high recording density such as Blu-ray Discs (also referred to as “BD”, hereinafter) and HD-DVD have been proposed.

Shortening of the absorption wavelength have been studied for azo metal complexes employed in DVD-Rs in optical recording disks employed with short-wavelength laser beams (such as 405 nm blue laser beams), for example, in Japanese Unexamined Patent Publication (KOKAI) No. 2007-45147 or English language family member EP 1 903 561 A1, Japanese Unexamined Patent Publication (KOKAI) No. 2006-306070 or English language family member US 2009/0053455 A1, Japanese Unexamined Patent Publication (KOKAI) No. 2007-26541 or English language family member US 2006/0204706 A1, and Japanese Unexamined Patent Publication (KOKAI) No. 2000-168237. The contents of the above applications are expressly incorporated herein by reference in their entirety. Japanese Unexamined Patent Publication (KOKAI) No. 2004-291244, which is expressly incorporated herein by reference in its entirety, discloses an azo metal complex dye that can be applied to both DVD-Rs and optical information disks that employ short-wavelength lasers.

We evaluated the light resistance of the dye films and the recording and reproduction characteristics of optical information recording media corresponding to short-wavelength lasers, such as blue lasers, for the azo metal complexes described in the above applications. As a result, we found that neither the light resistance nor the recording and reproduction characteristics were satisfactory.

Further, it is desirable in the inexpensive, large-scale manufacturing of optical information recording media for dye solutions to be stable when stored for extended periods in the course of forming recording layers. However, the azo metal complexes described in the above applications were determined to afford insufficient storage stability in solution.

### SUMMARY OF THE INVENTION

An aspect of the present invention provides for an optical information recording medium affording good light resistance and recording characteristics in information-recording by irradiation with short-wavelength laser beams (particularly information-recording by irradiation with laser beams with wavelengths of equal to or shorter than 440 nm), and a novel compound that is suitable for use as a dye in the recording layers of optical information recording media and that affords good storage stability in solution.

We conducted extensive research into achieving the above-stated medium and compound, resulting in the idea of suitably selecting the coordinating atoms bonding to metals and the number of members in rings formed in the course of chelating metal ions with ligands based on the notion that the coordination strength of ligands is a factor with regard to light resistance and stability in solution. We performed extensive research based on this idea, resulting in the discovery that azo metal complex dyes containing specific azo ligands exhibited extremely good light resistance and good stability in solution, as well as good recording characteristics with short-wavelength laser beams. The present invention was devised on that basis.

An aspect of the present invention relates to an optical information recording medium comprising a recording layer on a surface of a support, wherein the surface of the support has pregrooves with a track pitch ranging from 50 to 500 nm, the recording layer comprises an azo metal complex dye in the form of a complex of at least one azo dye denoted by general formula (1) and at least one metal ion:

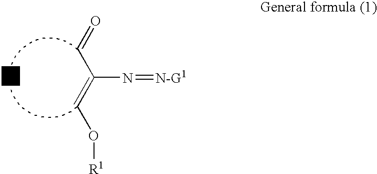

wherein, in general formula (1), Q¹ denotes an atom group forming a ring with two adjacent carbon atoms and a carbon atom bonded to —N═N-group, G¹ denotes a heterocyclic group or carbocyclic group, and R¹ denotes an alkyl group, alkenyl group, alkynyl group, aryl group, or heterocyclic group.

In general formula (1), G¹ may denote the following partial structure:

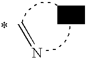

wherein, in the above partial structure, * denotes a binding position with —N═N-group, and Q² denotes an atom group forming a nitrogen-containing heterocyclic ring with an adjacent carbon atom and nitrogen atom.

The ring formed by Q¹ with the two adjacent carbon atoms and the carbon atom bonded to —N═N-group may be a six-membered ring or a condensed ring structure obtained by condensing a six-membered ring.

In general formula (1), the following partial structure:

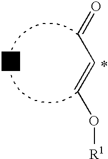

may denote one of the following partial structures (C-1) to (C-4):

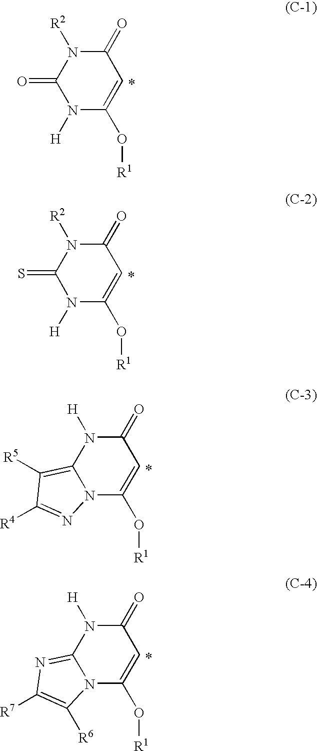

wherein, in the above partial structures, * denotes a binding position with —N═N-group, R¹ is defined as in general formula (1), R² denotes a hydrogen atom, alkyl group, alkenyl group, alkynyl group, aryl group, or heterocyclic group, each of R⁴ to R⁷ independently denotes a hydrogen atom or substituent, and adjacent substituents may bond together to form a ring.

In general formula (1), G¹ may denote a pyrazole ring, imidazole ring, isooxazole ring, 1,3,4-thiadiazole ring, 1,2,4-thiadiazole ring, or triazole ring.

The azo dye denoted by general formula (1) may be an azo dye denoted by general formula (3), (4), (5), or (6):

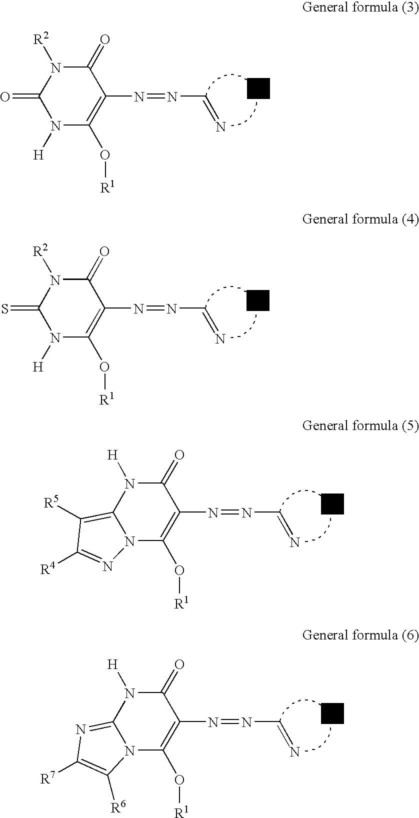

wherein, in general formulas (3), (4), (5), and (6), Q³ denotes an atom group forming a pyrazole ring, imidazole ring, isooxazole ring, 1,3,4-thiadiazole ring, or triazole ring with an adjacent carbon atom and nitrogen atom, R¹ is defined as in general formula (1), and R² and R⁴ to R⁷ are defined respectively as in (C-1) to (C-4).

The metal ion may be a transition metal ion, and the transition metal may be Mn, Fe, Co, Ni, Cu, or Zn, desirably Co, Ni, or Cu, and preferably, Cu.

Information may be recorded by irradiation of a laser beam having a wavelength of equal to or shorter than 440 nm.

The optical information recording medium may further comprise a reflective layer between the support and the recording layer, and the laser beam may be irradiated onto the recording layer from an opposite surface side, the opposite surface being opposite from the support.

A further aspect of the present invention relates to a method of recording and reproducing information comprising:

recording information on the recording layer comprised in the above optical recording medium and reproducing the information, and

conducting the recording and reproducing by irradiation of a laser beam having a wavelength of equal to or shorter than 440 nm onto the optical information recording medium.

A still further aspect of the present invention relates to an azo metal complex dye being a complex of at least one azo dye denoted by general formula (3), (4), (5), or (6) and at least one metal ion:

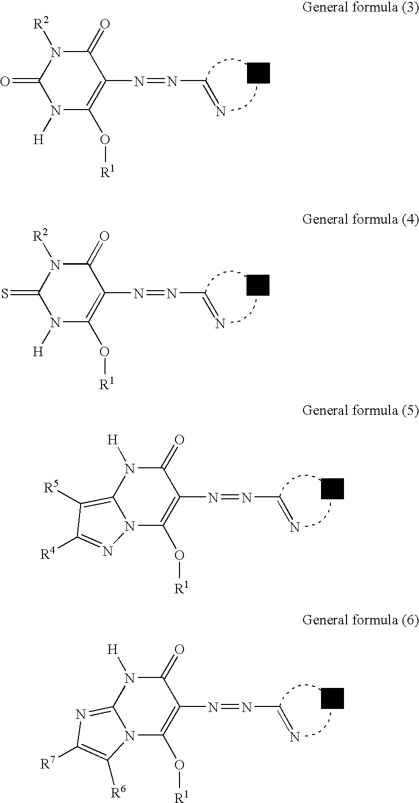

wherein, in general formulas (3), (4), (5), and (6), Q³ denotes an atom group forming a pyrazole ring, imidazole ring, isooxazole ring, 1,3,4-thiadiazole ring, or triazole ring with an adjacent carbon atom and nitrogen atom, R¹ denotes an alkyl group, alkenyl group, alkynyl group, aryl group, or heterocyclic group, R² denotes a hydrogen atom, alkyl group, alkenyl group, alkynyl group, aryl group, or heterocyclic group, each of R⁴ to R⁷ independently denotes a hydrogen atom or substituent, and adjacent substituents may bond together to form a ring.

The metal ion may be a transition metal ion, and the transition metal may be Mn, Fe, Co, Ni, Cu, or Zn, desirably Co, Ni, or Cu, and preferably, Cu.

The azo metal complex dye according to an aspect of the present invention can exhibit excellent light resistance and stability in solution.

An aspect of the present invention can provide an optical information recording medium affording good recording and reproduction characteristics with a blue laser beam having a wavelength of equal to or shorter than 440 nm as well as having extremely good light resistance (in particular, an optical information recording medium permitting the recording of information by irradiation of a laser beam with a wavelength of equal to or shorter than 440 nm).

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic sectional view of an example of the optical information recording medium of the present invention.

Explanations of symbols in the drawings are as follows:

10A First optical information recording medium

12 First support

14 First recordable recording layer

16 Cover layer

18 First light reflective layer

20 Barrier layer

22 First bonding layer or first adhesive layer

42 First objective lens

44 Hard coat layer

46 Laser beam

### DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The optical information recording medium, the method of recording and reproducing information, and the azo metal complex dye of the present invention will be described in detail below.

### Optical Information Recording Medium

The optical information recording medium of the present invention comprises a recording layer on a surface of a support. The surface of the support on which the recording layer is provided has pregrooves with a track pitch ranging from 50 to 500 nm. The optical information recording medium of the present invention is suitable as a high-density recording optical disk for recording and reproducing information with short-wavelength lasers, such as a BD or HD-DVD.

The above high-density recording optical disk is structurally characterized by a narrower track pitch than that of conventional recordable optical disks. Further, optical disks with the BD configuration have a layer structure comprising a recording layer, either directly, or over a layer such as a reflective layer, on the surface of a support, and having a relatively thin layer with a light-transmitting property (generally known as a “cover layer”) on the recording layer. In such an optical information recording medium with a structure differing from that of conventional recordable optical information recording media, it is difficult to achieve adequate recording characteristics with the recording dyes employed in conventional recordable optical disks, such as CD-Rs and DVD-Rs.

By contrast, incorporating at least one azo metal complex dye in the form of a complex of at least one metal ion and at least one azo dye denoted by general formula (1) into a recording layer can yield good recording and reproduction characteristics with the optical information recording medium of the present invention. The optical information recording medium of the present invention can afford good recording characteristics when irradiated with a laser beam of short wavelength (for example, a wavelength of equal to or shorter than 440 nm). In particular, the optical information recording medium of the present invention is suitable as a BD-configured medium comprising a configuration with a reflective layer between a support and a recording layer. Further, the above azo metal complex dye was discovered to exhibit extremely good light resistance and good solution stability. The optical information recording medium of the present invention incorporates the above azo metal complex dye into the recording layer, thereby achieving both good recording characteristics by irradiation with a short-wavelength laser beam, and a high degree of light resistance. Further, the optical information recording medium of the present invention can be manufactured with high productivity because it can be fabricated using a recording layer dye with high storage stability in solution.

The azo metal complex dye in the present invention will be described in detail below.

In the present invention, azo dyes are only described for the azo form in azo-hydrazone tautomeric equilibrium, but may also be in the corresponding hydrazone form. In that case, the hydrazone form is to be considered as the same component as the azo form in the present invention.

The optical information recording medium of the present invention comprises at least one azo metal complex dye in the form of a complex of at least one azo dye denoted by general formula (1) and at least one metal ion in the recording layer.

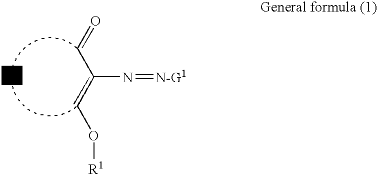

It suffices for the azo metal complex dye to be a complex comprising constituent components in the form of at least one metal ion and at least one azo dye denoted by general formula (1). In addition to the azo dye and metal ion, other components such as ions necessary to neutralize the charges of molecules and ligands may also be incorporated.

In general formula (1), R¹ denotes an alkyl group, alkenyl group, alkynyl group, aryl group, or heterocyclic group. The alkyl group, alkenyl group, alkynyl group, aryl group, and heterocyclic group may be substituted or unsubstituted. Those substituents described below as substituents that may be incorporated into Q¹ are examples of substituents that may be incorporated into R¹.

In general formula (1), the alkyl group denoted by R¹ may be a linear, branched, or cyclic alkyl group, and is desirably an alkyl group having 1 to 30 total carbon atoms, preferably 1 to 25 total carbon atoms, and more preferably, 1 to 20 total carbon atoms. Examples are methyl, ethyl, n-propyl, isopropyl, n-butyl, isobutyl, tert-butyl, n-hexyl, n-octyl, n-nonyl, isononyl, tert-nonyl, cyclohexyl, decyl, dodecyl, tetradecyl, hexadecyl, octadecyl, 4-chlorobenzyl, (4-ethoxyphenyl)methyl, N,N-diethylcarbamoylmethyl, 3-dodecyloxypropyl, and 2-methoxyethyloxy groups.

In general formula (1), the alkenyl group denoted by R¹ may be a linear, branched, or cyclic alkenyl group, and is desirably an alkenyl group having 2 to 30 total carbon atoms, preferably 2 to 25 total carbon atoms, and more preferably, 1 to 20 total carbon atoms. Examples are vinyl, allyl, prenyl, geranyl, and oleyl groups.

In general formula (1), the alkynyl group denoted by R¹ may be a linear, branched, or cyclic alkynyl group, and is desirably an alkynyl group having 2 to 30 total carbon atoms, preferably 2 to 25 total carbon atoms, and more preferably, 1 to 20 total carbon atoms. Examples are ethynyl and propargyl groups.

In general formula (1), the aryl group denoted by R¹ is desirably an aryl group having 6 to 30 total carbon atoms, preferably 6 to 25 total carbon atoms, and more preferably, 6 to 20 total carbon atoms. Examples are phenyl, naphthyl, anthracenyl, phenanthryl, pyrenyl, and perylenyl groups.

In general formula (1), the heterocyclic group denoted by R¹ may be either a saturated or unsaturated heterocyclic group, and is desirably a three- to eight-membered heterocyclic group, preferably a four- to eight-membered heterocyclic group, and more preferably, a five- to seven-membered heterocyclic group. Examples of hetero rings are oxazole, thiazole, imidazole, pyrazole, triazole, isooxazole, isothiazole, furan, thiophene, pyrrole, pyridine, pyrimidine, and triazine rings. However, in this case, the heterocyclic group denoted by R¹ is not bonded to an oxygen atom by a hetero atom moiety. The heterocyclic group may be a benzo condensed ring.

In general formula (1), Q¹ denotes an atom group forming a ring with two adjacent carbon atoms and a carbon atom bonded to —N═N-group. The ring formed is not specifically limited. From the perspective of ease of synthesis and light resistance, a six-membered ring or a condensed ring structure obtained by condensing a six-membered ring is desirable. The ring desirably comprises one or more from among a carbon atom, oxygen atom, nitrogen atom, or sulfur atom. The ring formed by Q¹ may be substituted with at least one substituent (also referred to as “substituent R²⁰” hereinafter), or may be a condensed ring. The substituent denoted by R²⁰ is not specifically limited. Examples are halogen atoms, alkyl groups (including cycloalkyl groups and bicycloalkyl groups), alkenyl groups (including cycloalkenyl groups and bicycloalkenyl groups), alkynyl groups, aryl groups, heterocyclic groups, cyano groups, hydroxyl groups, nitro groups, carboxyl groups, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups (including anilino groups), acylamino groups, aminocarbonylamino groups, alkoxycarbonylamino groups, aryloxycarbonylamino groups, sulfamoylamino groups, alkyl and arylsulfonylamino groups, mercapto groups, alkylthio groups, arylthio groups, heterocyclic thio groups, sulfamoyl groups, sulfo groups, alkyl and arylsulfinyl groups, alkyl and arylsulfonyl groups, acyl groups, aryloxycarbonyl groups, alkoxycarbonyl groups, carbamoyl groups, aryl and heterocyclic azo groups, imido groups, phosphino groups, phosphinyl groups, phosphinyloxy groups, phosphinylamino groups, and silyl groups.

Further specific examples of R²⁰ are: halogen atoms (such as chlorine, bromine, and iodine atoms); alkyl groups [linear, branched, and cyclic substituted and unsubstituted alkyl groups, including alkyl groups (desirably alkyl groups having 1 to 30 carbon atoms, such as methyl, ethyl, n-propyl, isopropyl, t-butyl, n-octyl, eicosyl, 2-chloroethyl, 2-cyanoethyl, and 2-ethylhexyl groups), cycloalkyl groups (desirably substituted or unsubstituted cycloalkyl groups having 3 to 30 carbon atoms, such as cyclohexyl groups, cyclopentyl groups, 4-n-dodecylcyclohexyl groups), bicycloalkyl groups (desirably substituted or unsubstituted bicycloalkyl groups having 5 to 30 carbon atoms, that is, monovalent groups consisting of a bicycloalkane having 5 to 30 carbon atoms from which one hydrogen atom has been removed, such as bicyclo[1,2,2]heptane-2-yl and bicyclo[2,2,2]octane-3-yl), and structures with even larger numbers of rings, such as tricyclo structures, the alkyl group in the substituents described further below (such as the alkyl group in an alkylthio group) also denoting an alkyl group based on this same concept)]; alkenyl groups [linear, branched, and cyclic substituted and unsubstituted alkenyl groups, including alkenyl groups (desirably substituted or unsubstituted alkenyl groups having 2 to 30 carbon atoms, such as vinyl groups, allyl groups, prenyl groups, geranyl groups, and oleyl groups), cycloalkenyl groups (desirably substituted or unsubstituted cycloalkenyl groups having 3 to 30 carbon atoms, that is, monovalent groups consisting of a cycloalkene having 3 to 30 carbon atoms from which a hydrogen atom has been removed, such as 2-cyclopentene-1-yl and 2-cyclohexene-1-yl), bicycloalkenyl groups (substituted or unsubstituted bicycloalkenyl groups, desirably substituted or unsubstituted bicycloalkenyl groups having 5 to 30 carbon atoms, that is, monovalent groups in the form of bicycloalkenes having a single double bond from which a hydrogen atom has been removed, such as bicyclo[2,2,1]hepto-2-en-1-yl and bicyclo[2,2,2]octo-2-en-4-yl]; alkynyl groups (desirably substituted or unsubstituted alkynyl groups having 2 to 30 carbon atoms, such as ethynyl groups, propargyl groups, and trimethylsilylethynyl groups); aryl groups (desirably substituted or unsubstituted aryl groups having 6 to 30 carbon atoms, such as phenyl groups, p-tolyl groups, naphthyl groups, m-chlorophenyl groups, and o-oxadecanoylaminophenyl groups); heterocyclic groups (monovalent groups consisting of five- or six-membered, substituted or unsubstituted, aromatic or nonaromatic heterocyclic compounds from which a hydrogen atom has been removed, preferably five- or six-membered aromatic heterocyclic groups having 3 to 30 carbon atoms, such as 2-furyl, 2-thienyl, 2-pyrimidinyl, and 2-benzothiazolyl groups); cyano groups; hydroxyl groups; nitro groups; carboxyl groups; alkoxy groups (desirably substituted or unsubstituted alkoxy groups having 1 to 30 carbon atoms, such as methoxy, ethoxy, isopropoxy, t-butoxy, n-octyloxy, and 2-methoxyethoxy groups); aryloxy groups (desirably substituted or unsubstituted aryloxy groups having 6 to 30 carbon atoms, such as phenoxy, 2-methylphenoxy, 4-t-butylphenoxy, 3-nitrophenoxy, and 2-tetradecanoylaminophenoxy groups); silyloxy groups (desirably silyloxy groups having 3 to 20 carbon atoms, such as trimethylsilyloxy and t-butyldimethylsilyloxy groups); heterocyclic oxy groups (desirably substituted or unsubstituted heterocyclic oxy groups having 2 to 30 carbon atoms, 1-phenyltetrazole-5-oxy groups, and 2-tetrahydropyranyloxy groups); acyloxy groups (desirably formyloxy groups, substituted or unsubstituted alkylcarbonyloxy groups having 2 to 30 carbon atoms, substituted or unsubstituted arylcarbonyloxy groups having 6 to 30 carbon atoms, such as formyloxy, acetyloxy, pivaloyloxy, stearoyloxy, benzoyloxy, and p-methoxyphenylcarbonyloxy groups); carbamoyloxy groups (desirably substituted or unsubstituted carbamoyloxy groups having 1 to 30 carbon atoms, such as N,N-dimethylcarbamoyloxy groups, N,N-diethylcarbamoyloxy groups, morpholinocarbonyloxy groups, N,N-di-n-octylaminocarbonyloxy groups, and N-n-octylcarbamoyloxy groups); alkoxycarbonyloxy groups (desirably substituted or unsubstituted alkoxycarbonyloxy groups having 2 to 30 carbon atoms, such as methoxycarbonyloxy, ethoxycarbonyloxy, t-butoxycarbonyloxy, and n-octylcarbonyloxy groups); aryloxycarbonyloxy groups (desirably substituted or unsubstituted aryloxycarbonyloxy groups having 7 to 30 carbon atoms, such as phenoxycarbonyloxy, p-methoxyphenoxycarbonyloxy, and p-n-hexadecyloxyphenoxycarbonyloxy groups), amino groups (desirably amino groups, substituted or unsubstituted alkyl amino groups having 1 to 30 carbon atoms, substituted or unsubstituted anilino groups having 6 to 30 carbon atoms, such as amino, methylamino, dimethylamino, anilino, N-methylanilino, and diphenylamino groups); acylamino groups (desirably formylamino groups, substituted or unsubstituted alkylcarbonylamino groups having 1 to 30 carbon atoms and substituted or unsubstituted arylcarbonylamino groups having 6 to 30 carbon atoms, such as formylamino, acetylamino, pivaloylamino, lauroylamino, benzoylamino, and 3,4,5-tri-n-octyloxyphenylcarbonylamino groups); aminocarbonylamino groups (desirably substituted or unsubstituted aminocarbonylamino groups having 1 to 30 carbon atoms, such as carbamoylamino, N,N-dimethylaminocarbonylamino, N,N-diethylaminocarbonylamino, and morpholinocarbonylamino groups); alkoxycarbonylamino groups (desirably substituted or unsubstituted alkoxycarbonyl amino groups having 2 to 30 carbon atoms, such as methoxycarbonylamino, ethoxycarbonylamino, t-butoxycarbonylamino, n-octadecyloxycarbonylamino, and N-methylmethoxycarbonylamino groups); aryloxycarbonylamino groups (desirably substituted or unsubstituted aryloxycarbonylamino groups having 7 to 30 carbon atoms, such as phenoxycarbonylamino, p-chlorophenoxycarbonylamino, and m-n-octyloxy-phenoxycarbonylamino groups); sulfamoylamino groups (desirably substituted or unsubstituted sulfamoylamino groups having 0 to 30 carbon atoms, such as sulfamoylamino, N,N-dimethylaminosulfonylamino, and N-n-octylaminosulfonylamino groups); alkyl and arylsulfonylamino groups (desirably substituted or unsubstituted alkyl-sulfonylamino groups having 1 to 30 carbon atoms and substituted or unsubstituted arylsulfonylamino groups having 6 to 30 carbon atoms, such as methylsulfonylamino, butylsulfonylamino, phenylsulfonylamino, 2,3,5-trichlorophenylsulfonylamino, and p-methylphenylsulfonylamino groups); mercapto groups; alkylthio groups (desirably substituted or unsubstituted alkylthio groups having 1 to 30 carbon atoms, such as methylthio, ethylthio, and n-hexadecylthio groups); arylthio groups (desirably substituted or unsubstituted arylthio groups having 6 to 30 carbon atoms, such as phenylthio, p-chlorophenylthio, and m-methoxyphenylthio groups); heterocyclic thio groups (desirably substituted or unsubstituted heterocyclic thio groups having 2 to 30 carbon atoms, such as 2-benzothiazolylthio and 1-phenyltetrazole-5-ylthio groups); sulfamoyl groups (desirably substituted or unsubstituted sulfamoylgroups having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl, and N-(N′-phenylcarbamoyl)sulfamoyl groups); sulfo groups; alkyl and arylsulfinyl groups (desirably substituted or unsubstituted alkylsulfinyl groups having 1 to 30 carbon atoms and substituted or unsubstituted arylsulfinyl groups having 6 to 30 carbon atoms, such as methylsulfinyl, ethylsulfinyl, phenylsulfinyl, and p-methylphenylsulfinyl groups); alkyl and arylsulfonyl groups (desirably substituted or unsubstituted alkylsulfonyl groups having 1 to 30 carbon atoms and substituted or unsubstituted arylsulfonyl groups having 6 to 30 carbon atoms, such as methylsulfonyl, ethylsulfonyl, phenylsulfonyl, and p-methylphenylsulfonyl groups); acyl groups (desirably formyl groups, substituted or unsubstituted alkylcarbonyl groups having 2 to 30 carbon atoms, substituted or unsubstituted arylcarbonyl groups having 7 to 30 carbon atoms, and substituted or unsubstituted heterocyclic carbonyl groups that have 4 to 30 carbon atoms in which the carbonyl group is bonded through a carbon atom, such as acetyl, pivaloyl, 2-chloroacetyl, stearoyl, benzoyl, p-n-octyloxyphenylcarbonyl, 2-pyridylcarbonyl, and 2-furylcarbonyl groups); aryloxycarbonyl groups (desirably substituted or unsubstituted aryloxycarbonyl groups having 7 to 30 carbon atoms, such as phenoxycarbonyl, o-chlorophenoxycarbonyl, m-nitrophenoxycarbonyl, and p-t-butylphenoxycarbonyl groups); alkoxycarbonyl groups (desirably substituted or unsubstituted alkoxycarbonyl groups having 2 to 30 carbon atoms, such as methoxycarbonyl, ethoxycarbonyl, t-butoxycarbonyl, and n-octadecyloxycarbonyl groups); carbamoyl groups (desirably substituted or unsubstituted carbamoyl groups having 1 to 30 carbon atoms, such as carbamoyl, N-methylcarbamoyl, N,N-dimethylcarbamoyl, N,N-di-n-octylcarbamoyl, and N-(methylsulfonyl)carbamoyl groups); aryl and heterocyclic azo groups (desirably substituted or unsubstituted aryl azo groups having 6 to 30 carbon atoms and substituted or unsubstituted heterocyclic azo groups having 3 to 30 carbon atoms, such as phenylazo, p-chlorophenylazo, and 5-ethylthio-1,3,4-thiadizaole-2-ylazo groups); imido groups (desirably N-succinimide and N-phthalimide groups), phosphino groups (desirably substituted or unsubstituted phosphino groups having 2 to 30 carbon atoms, such as dimethylphosphino, diphenylphosphino, and methylphenoxyphosphino groups); phosphinyl groups (desirably substituted or unsubstituted phosphinyl groups having 2 to 30 carbon atoms, such as phosphinyl groups, dioctyloxyphosphinyl groups, and diethoxyphoshinyl groups); phosphinyloxy groups (desirably substituted or unsubstituted phosphinyloxy groups having 2 to 30 carbon atoms, such as diphenoxyphosphinyloxy and dioctyloxyphosphinyloxy groups); phosphinylamino groups (desirably substituted or unsubstituted phosphinylamino groups having 2 to 30 carbon atoms, such as dimethoxyphosphinylamino and dimethylaminophosphinylamino groups); and silyl groups (desirably substituted or unsubstituted silyl groups having 3 to 30 carbon atoms, such as trimethylsilyl, t-butyldimethylsilyl, and phenyldimethylsilyl groups).

Hydrogen atoms can be removed and substituted with the above substituents in those of the above functional groups that comprise hydrogen.

R²⁰ desirably denotes a substituted or unsubstituted alkyl group having 1 to 10 carbon atoms, substituted or unsubstituted aryl group having 6 to 20 carbon atoms, substituted or unsubstituted alkoxy group having 1 to 10 carbon atoms, substituted or unsubstituted aryloxy group having 6 to 20 carbon atoms, substituted or unsubstituted acyl group having 2 to 10 carbon atoms, substituted or unsubstituted alkoxycarbonyl group having 2 to 10 carbon atoms, or substituted or unsubstituted alkylsulfonyl group having 1 to 10 carbon atoms; preferably denotes a substituted or unsubstituted alkyl group having 1 to 8 carbon atoms or substituted or unsubstituted aryl group having 6 to 15 carbon atoms; and more preferably, denotes a substituted or unsubstituted alkyl group having 1 to 6 carbon atoms. Among the alkyl groups, branched alkyl groups having 3 to 6 carbon atoms are desirable, and tertiary alkyl groups having 4 to 6 carbon atoms are preferred.

In general formula (1), (B-1) to (B-8) below are specific examples of the partial structure indicated below.

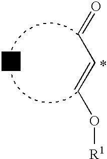

[In the above partial structure, * denotes a binding position with —N═N-group.]

Of these, any one of (B-1) to (B-5) is desirable, any one of (B-1) to (B-4) is preferred, any one of (C-1) to (C-4) is of greater preference, (C-1) or (C-3) is of still greater preference, with (C-3) being particularly preferred.

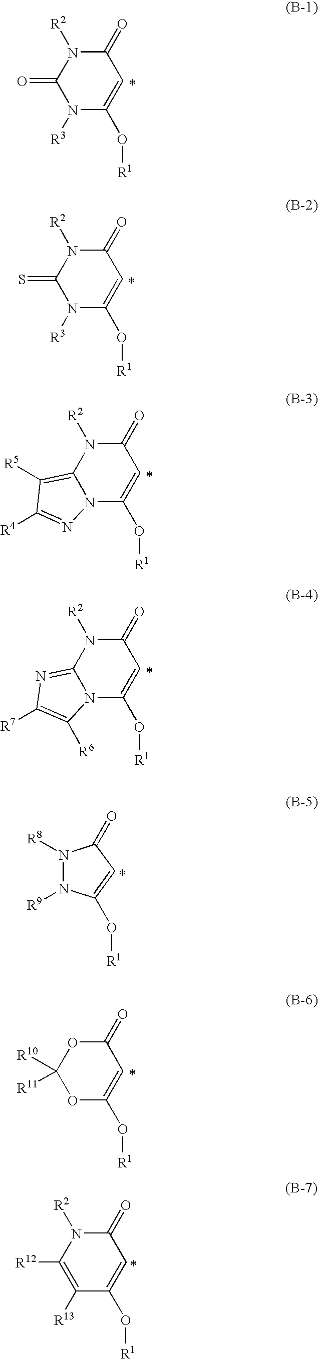

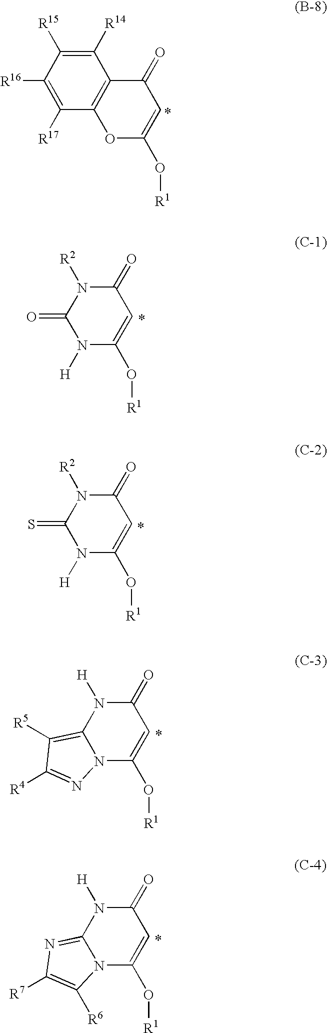

In the above partial structures, * denotes a binding position with —N═N-group; R¹ is defined as in general formula (1); and each of R² and R³ independently denotes a hydrogen atom, alkyl group, alkenyl group, alkynyl group, aryl group, or heterocyclic group. The details of alkyl groups, alkenyl groups, alkynyl groups, aryl groups, and heterocyclic groups denoted by R² and R³ are identical to the details of the alkyl group, alkenyl group, alkynyl group, aryl group, and heterocyclic group denoted by R¹ in general formula (1). Each of R⁴ to R⁷ independently denotes a hydrogen atom or substituent, and adjacent substituents may bond together to form a ring. The substituents denoted by R⁴ to R⁷ are not specifically limited; examples are those given by way of example for the substituent denoted by R²⁰.

From the perspective of solubility, R⁴ and R⁵ desirably denote hydrogen atoms, alkyl groups, alkenyl groups, alkynyl groups, aryl group, heterocyclic rings, alkoxy groups, acylamino groups, or alkoxycarbonyl groups.

From the perspective of solubility, R⁶ and R⁷ desirably denote hydrogen atoms, alkyl groups, alkenyl groups, alkynyl groups, aryl groups, heterocyclic rings, alkoxy groups, acrylamino groups, or alkoxycarbonyl groups.

G¹ denotes a heterocyclic group or a carbocyclic group, desirably a heterocyclic group. The carbocyclic group or heterocyclic group may comprise one or more substituent, and may be a condensed ring. From the perspective of increasing solubility, the presence of a substituent is desirable. A monocycle comprising a substituent is preferred. The substituent is not specifically limited; examples are the substituents given by way of example for R²⁰.

When G¹ is a carbocyclic group, an atom that is covalently bonded or coordination-bonded to a metal ion will desirably be present on a substituent contained in G¹. When G¹ denotes a carbocyclic group, a phenyl group is desirable.

When G¹ is a heterocyclic group, an atom that is covalently bonded or coordination-bonded to a metal ion will be present on the ring of G¹, or on a substituent contained in G¹.

When G¹ denotes a heterocyclic group, the heterocyclic ring is not specifically limited. Examples are: a pyrazole ring, pyrrole ring, furan ring, thiophene ring, imidazole ring, thiazole ring, oxazole ring, isothiazole ring, isooxazole ring, 1,3,4-thiadiazole ring, 1,3,4-oxadiazole ring, 1,2,4-thiadiazole ring, 1,2,4-oxadiazole ring, triazole ring, pyridine ring, pyrazine ring, pyrimidine ring, pyridazine ring, and triazine ring. A pyrazole ring, imidazole ring, isothiazole ring, isooxazole ring, 1,3,4-thiadiazole ring, 1,3,4-oxadiazole ring, 1,2,4-thiadiazole ring, 1,2,4-oxadiazole ring, or triazole ring is desirable. A pyrazole ring, imidazole ring, isooxazole ring, 1,3,4-thiadiazole ring, 1,2,4-thiadiazole ring, or triazole ring is preferred. A pyrazole ring, imidazole ring, isooxazole ring, 1,3,4-thiadiazole ring, or triazole ring is of greater preference. A pyrazole ring or isooxazole ring is of still greater preference. And a pyrazole ring is particularly preferred.

Specific examples of the azo dye denoted by general formula (1) above will be given. However, the present invention is not limited thereto.

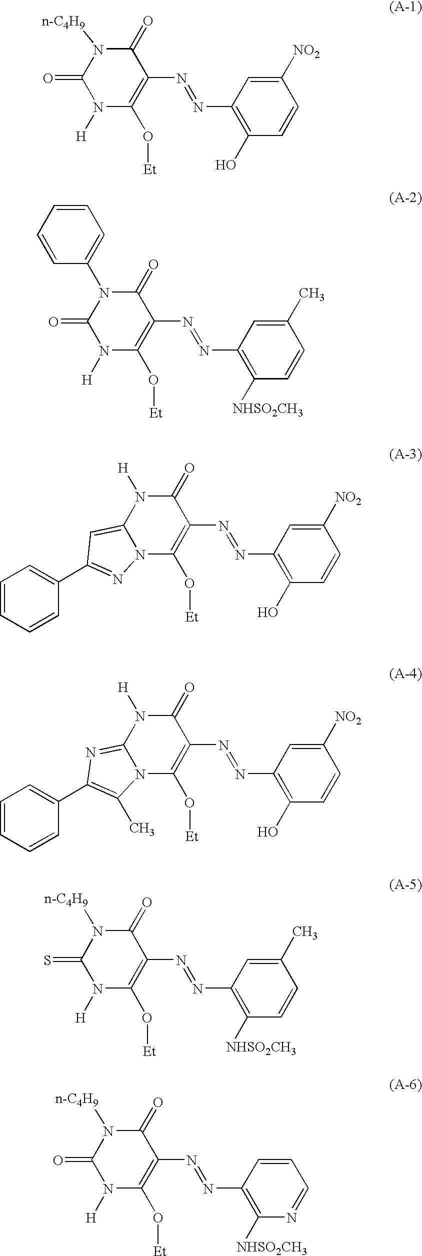

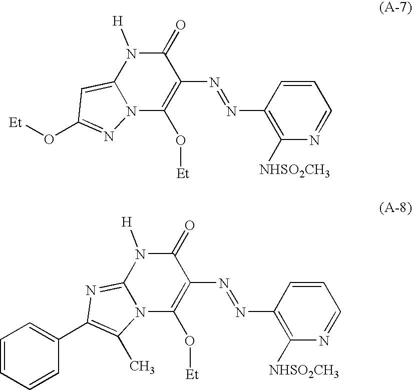

The metal ions forming a complex with the azo dye denoted by general formula (1) will be described next. Examples are ions of the metals: Mg, Al, Si, Ca, Sc, Ti, V, Cr, Mn, Fe, Co, Ni, Cu, Zn, Ga, Ge, As, Sr, Y, Zr, Nb, Mo, Tc, Ru, Rh, Pd, Ag, Cd, In, Sn, Sb, Ba, Pr, Eu, Yb, Hf, Ta, W, Re, Os, Ir, Pt, Au, Hg, Tl, Pb, Bi, and Th. The metal ion may be in the form of a metal oxide ion. Examples of such metal oxide ions are oxides of these metals.

Among the above, ions of transition metal atoms are desirable. The transition metal atoms include the elements of groups IIIa to VIII and group Ib in the Periodic Table of the Elements; they are elements with an incomplete d-electron shell. The transition metal atom is not specifically limited. From the perspectives of ease of synthesis and recording characteristics, Mn, Fe, Co, Ni, Cu, and Zn are desirable. From the perspective of light resistance, Co, Ni, and Cu are preferred, and Cu is of greater preference.

Divalent and trivalent metal ions are desirable as the metal ion forming a complex with the azo dye denoted by general formula (1). Examples of divalent and trivalent metal ions are: Mn²⁺, Fe²⁺, Fe³⁺, Co²⁺, Co³⁺, Ni²⁺, Ni³⁺, Cu²⁺, Zn²⁺, Cr³⁺, Ru²⁺, Rh³⁺, Pd²⁺, Ir³⁺, and Pt²⁺. Mn²⁺, Fe²⁺, Fe³⁺, Co²⁺, Co³⁺, Ni²⁺, Ni³⁺, Cu²⁺, and Zn²⁺ are desirable; and Co²⁺, Co³⁺, Ni²⁺, Ni³⁺, and Cu²⁺ are preferred.

An example of a desirable form of the azo dye denoted by general formula (1) is an azo dye in which G¹ in general formula (1) denotes the following partial structure:

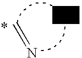

wherein, * denotes a binding position with —N═N-group, and Q² denotes an atom group forming a nitrogen-containing heterocyclic ring with an adjacent carbon atom and nitrogen atom, that is, an azo dye denoted by general formula (2) below.

General Formula (2)

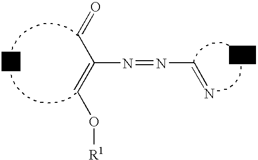

In general formula (2), R¹ and Q¹ are defined identically with R¹ and Q¹ in general formula (1), and the details thereof, such as desirable embodiments, are identical thereto.

Q² denotes an atom group forming a nitrogen-containing heterocyclic ring with an adjacent carbon atom and nitrogen atom. The nitrogen-containing heterocyclic group is not specifically limited. Examples are: a pyrazole ring, imidazole ring, thiazole ring, oxazole ring, isothiazole ring, isooxazole ring, 1,3,4-thiadiazole ring, 1,3,4-oxadiazole ring, 1,2,4-thiadiazole ring, 1,2,4-oxadiazole ring, triazole ring, pyridine ring, pyrazine ring, pyrimidine ring, pyridazine ring, and triazine ring. A pyrazole ring, imidazole ring, isothiazole ring, isooxazole ring, 1,3,4-thiadiazole ring, 1,3,4-oxadiazole ring, 1,2,4-thiadiazole ring, 1,2,4-oxadiazole ring, or triazole ring is desirable. A pyrazole ring, imidazole ring, isooxazole ring, 1,3,4-thiadiazole ring, 1,2,4-thiadiazole ring, or triazole ring is preferred. A pyrazole ring, imidazole ring, isooxazole ring, 1,3,4-thiadiazole ring, or triazole ring is of greater preference. A pyrazole ring or isooxazole ring is of still greater preference. And a pyrazole ring is particularly preferred.

Among the azo dyes denoted by general formula (2), specific examples in which Q² forms a pyrazole ring are given below. However, the present invention is not limited thereto.

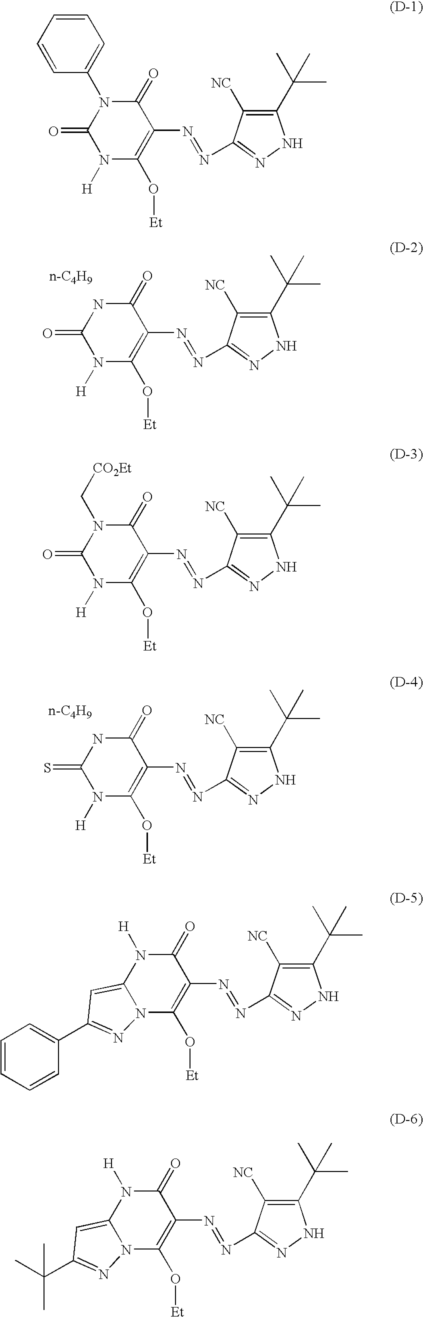

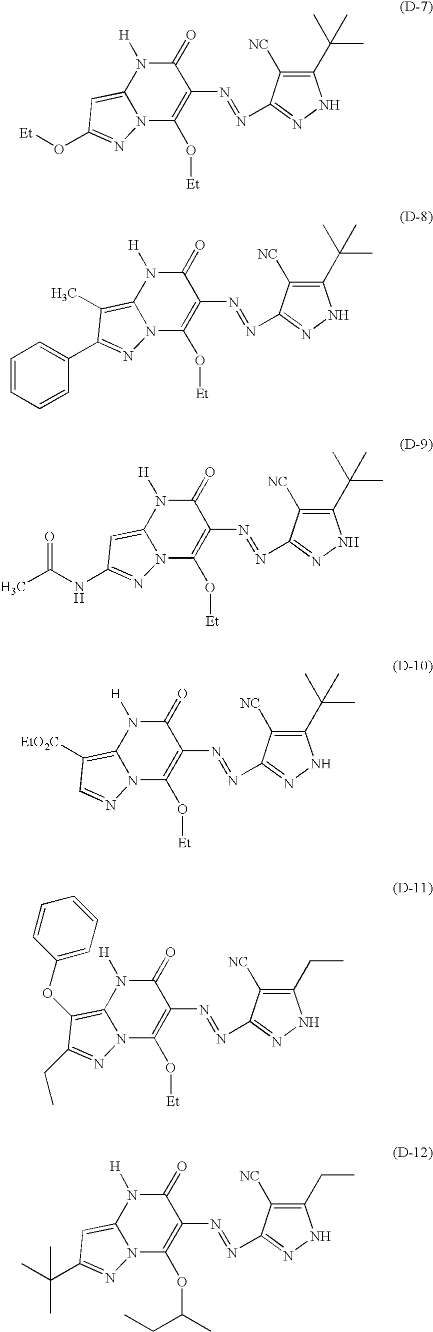

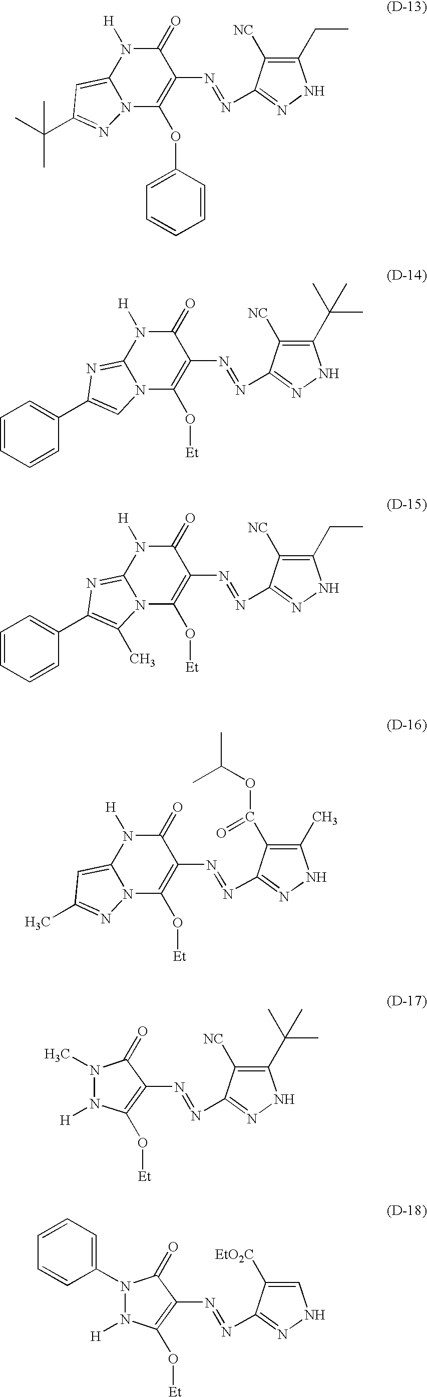

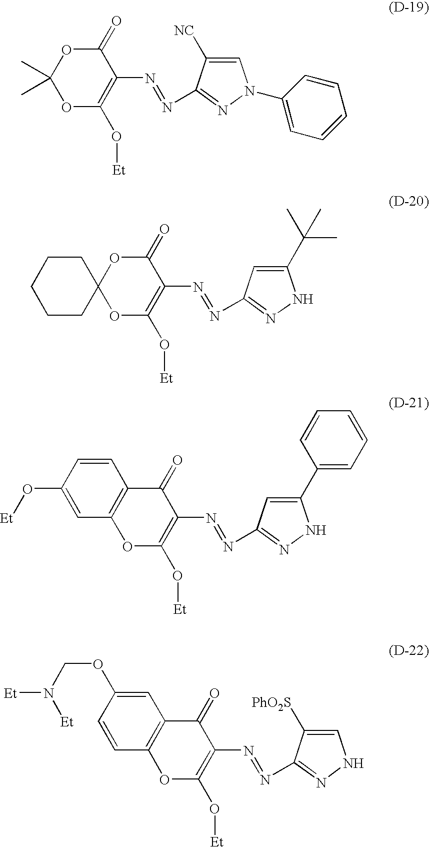

Among the azo dyes denoted by general formula (2), specific examples in which Q² forms an isooxazole ring are given below. However, the present invention is not limited thereto.

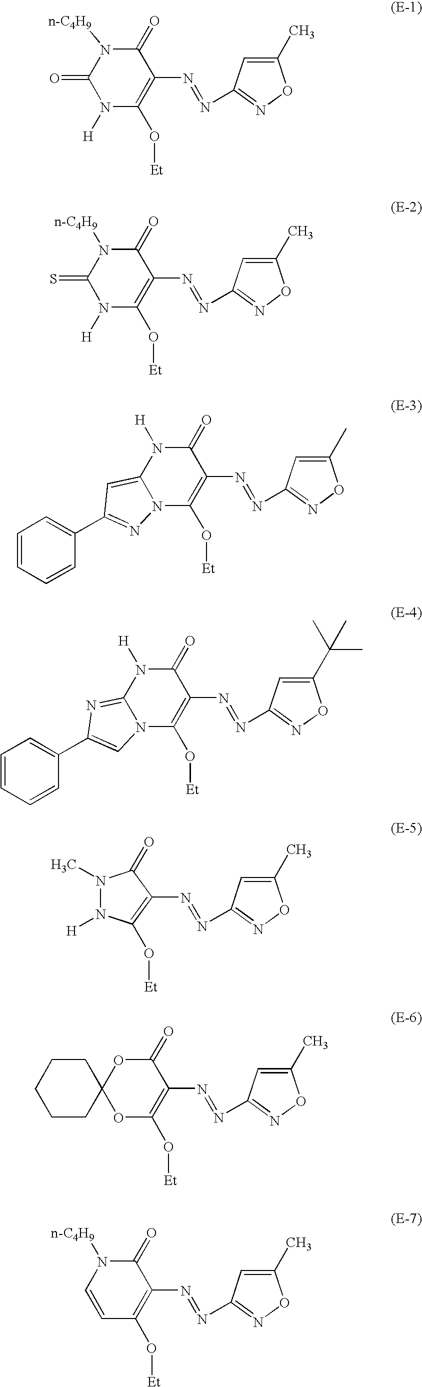

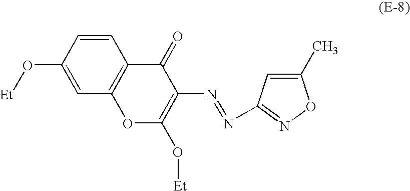

Among the azo dyes denoted by general formula (2), specific examples in which Q² forms a 1,3,4-thiadiazole ring are given below. However, the present invention is not limited thereto.

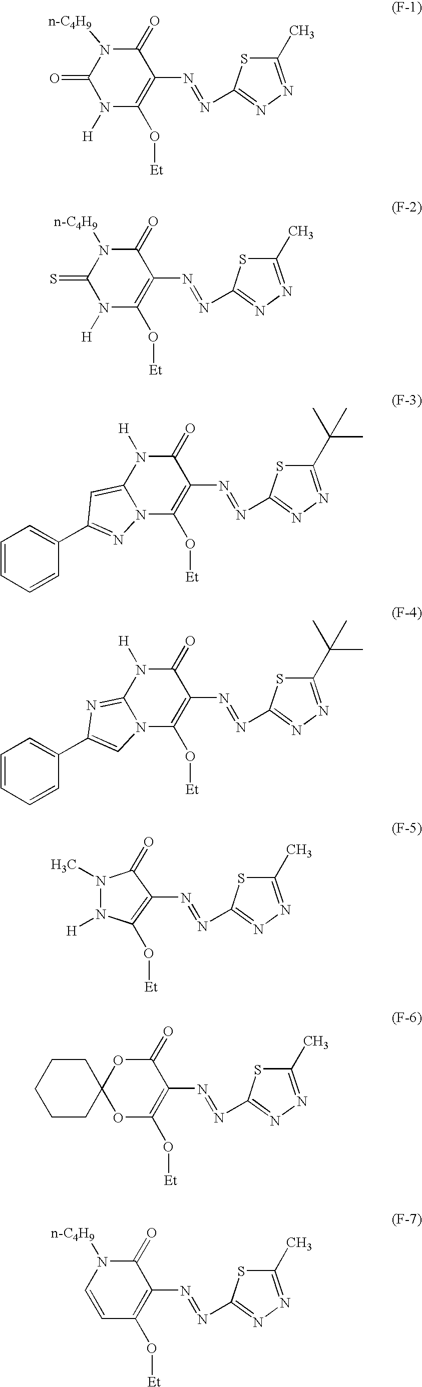

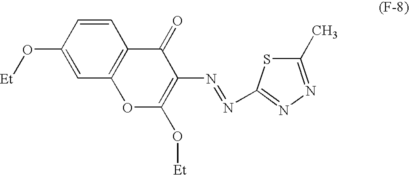

Among the azo dyes denoted by general formula (2), specific examples in which Q² forms an imidazole ring are given below. However, the present invention is not limited thereto.

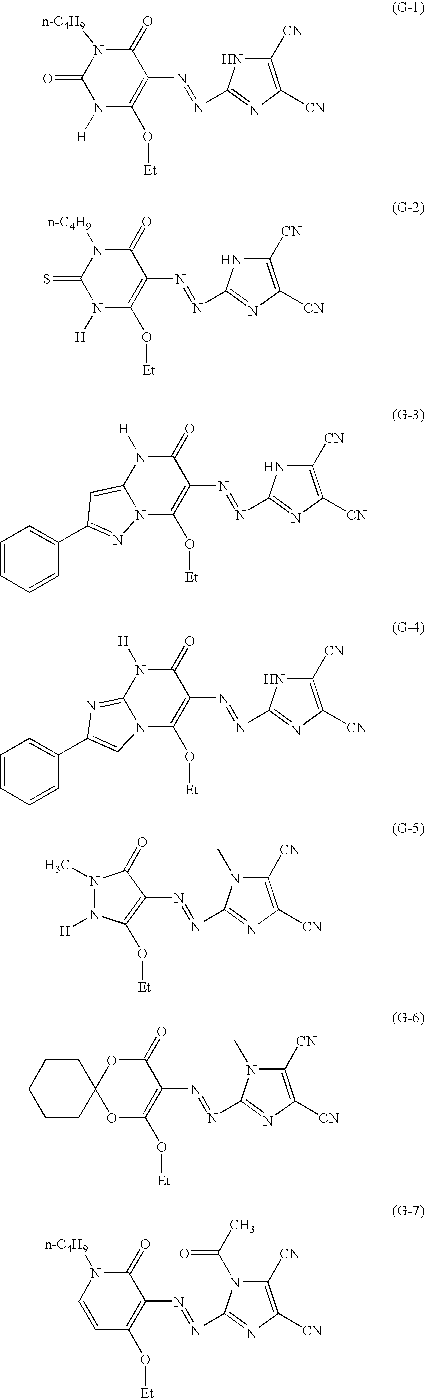

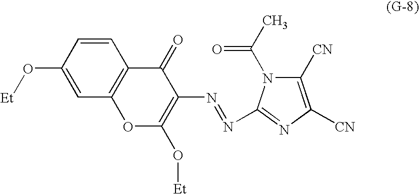

Among the azo dyes denoted by general formula (2), specific examples in which Q² forms a triazole ring are given below. However, the present invention is not limited thereto.

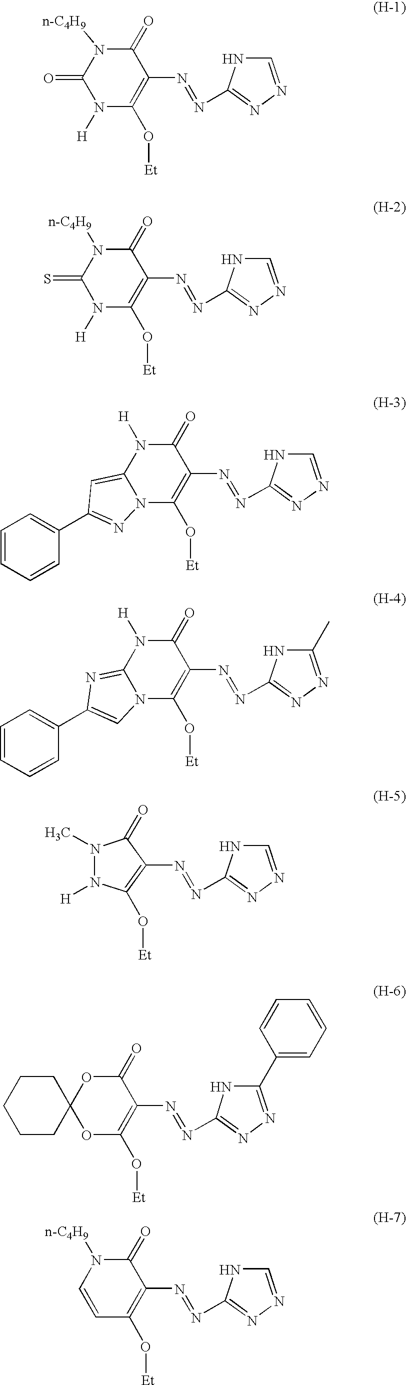

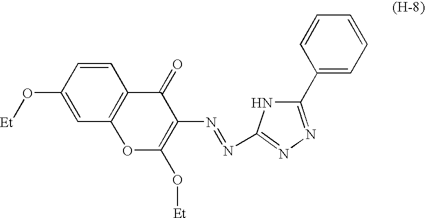

The azo dyes denoted by general formulas (3) to (6) below are further examples of desirable forms of the azo dye denoted by general formula (1).

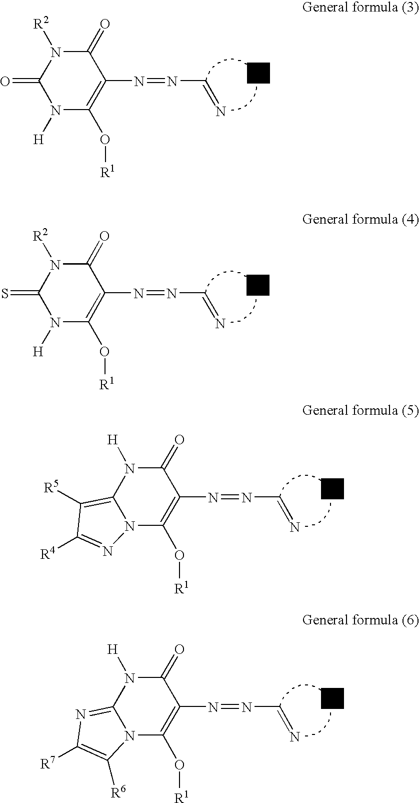

In general formulas (3), (4), (5), and (6), Q³ denotes an atom group forming a pyrazole ring, imidazole ring, isooxazole ring, 1,3,4-thiadiazole ring, or triazole ring with an adjacent carbon atom and nitrogen atom. R¹ is defined as in general formula (1), and the details thereof, such as the desirable embodiments, are identical thereto. R² and R⁴ to R⁷ are defined as in (C-1) to (C-4), respectively, and the details thereof, such as the desirable ranges, are identical thereto.

Specific examples of the azo metal complex dye of the present invention are given below. However, the present invention is not limited thereto. The azo metal complex dyes indicated below can be obtained by reacting metal ions with an azo dye ligand.

TABLE 1

| Azo metal complex dye | Metal ion | Ligand |
|---|---|---|
| (M-1) | Cu²⁺ | (D-1) |
| (M-2) | Cu²⁺ | (D-2) |
| (M-3) | Cu²⁺ | (D-3) |
| (M-4) | Cu²⁺ | (D-4) |
| (M-5) | Cu²⁺ | (D-5) |
| (M-6) | Cu²⁺ | (D-6) |
| (M-7) | Cu²⁺ | (D-7) |
| (M-8) | Cu²⁺ | (D-8) |
| (M-9) | Cu²⁺ | (D-10) |
| (M-10) | Cu²⁺ | (D-15) |
| (M-11) | Co²⁺ | (D-5) |
| (M-12) | Ni²⁺ | (D-5) |
| (M-13) | Fe²⁺ | (D-5) |
| (M-14) | Cu²⁺ | (E-1) |
| (M-15) | Cu²⁺ | (E-3) |
| (M-16) | Fe²⁺ | (E-1) |
| (M-17) | Ni²⁺ | (E-1) |
| (M-18) | Co²⁺ | (E-1) |
| (M-19) | Mn²⁺ | (E-1) |
| (M-20) | Fe²⁺ | (E-3) |
| (M-21) | Ni²⁺ | (E-3) |
| (M-22) | Co²⁺ | (E-3) |
| (M-23) | Zn²⁺ | (E-3) |
| (M-24) | Cu²⁺ | (F-1) |
| (M-25) | Cu²⁺ | (F-3) |
| (M-26) | Cu²⁺ | (G-1) |
| (M-27) | Cu²⁺ | (G-3) |
| (M-28) | Cu²⁺ | (H-1) |
| (M-29) | Cu²⁺ | (H-3) |
| (M-30) | Fe²⁺ | (F-3) |
| (M-31) | Fe²⁺ | (G-3) |
| (M-32) | Fe²⁺ | (H-3) |

Methods of synthesizing the above azo metal complex dyes will be described next.

The methods described in Japanese Unexamined Patent Publication (KOKAI) Showa No. 61-36362 and Japanese Unexamined Patent Publication (KOKAI) No. 2006-57076, which are expressly incorporated herein by reference in their entirety, are examples of common methods of synthesizing the azo dye denoted by general formula (1). However, there is no limitation to these methods; other reaction solvents and acids may be employed, and the coupling reaction may be conducted in the presence of a base (such as sodium acetate, pyridine, or sodium hydroxide). Specific examples of methods of synthesizing the azo dye are given below.

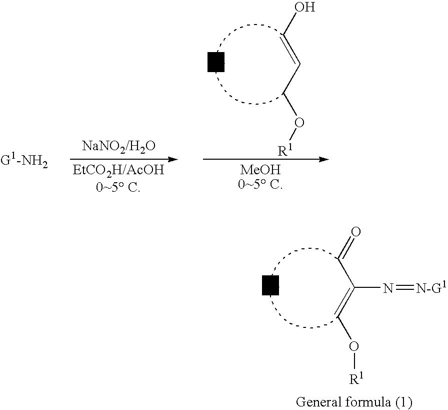

[In the above scheme, G¹, Q¹ and R¹ are defined respectively as described above.]

The above scheme is an example in which synthesis is conducted with a coupler into which substituent R¹ has already been incorporated. However, as indicated in the following scheme, substituent R¹ can be incorporated by a suitable method following the coupling reaction.

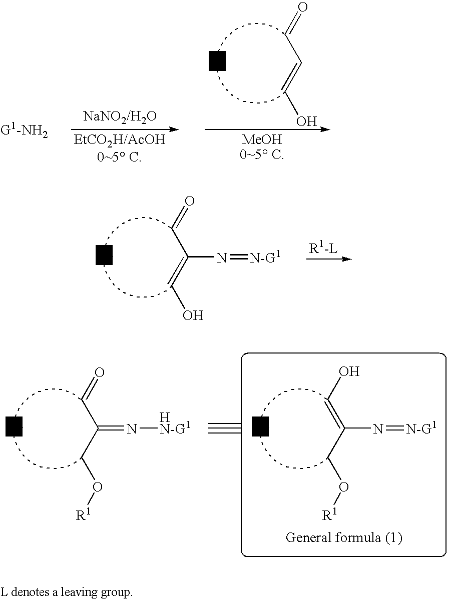

One example of a common method of obtaining a metal azo chelate dye by reacting an azo dye and a metal ion is to stir an azo dye and a metal salt (including a metal complex or a metal oxide salt) in an organic solvent, water, or a mixed solution thereof. However, types of metal salt, organic solvent or mixed solution thereof, reaction temperature and the like are not limited. The reaction can be conducted in the presence of a base. Types of the base employed are also not limited. The azo metal complex dye is preferably obtained through the reaction in the presence of a base.

A specific example of the method of synthesizing the azo metal complex dye is a method in which hot refluxing is conducted with a reaction solvent in the form of an alcohol-based solvent such as methanol or ethanol, and a base in the form of an amine, amidine (such as DBU((1,8-diazabicyclo[5.4.0]-7-undecene))), guanidine, inorganic base (such as NaOH), or the like. However, this is not a limitation. Reaction conditions such as the reaction solvent, concentration and blending ratio of the azo dye and metal salt in the reaction solution, reaction temperature, and reaction time can be suitably established.

The structure of the azo metal complex can be confirmed with a known method, such as ESI-MS, MALDI-MS, ESR, X-ray structural analysis, and the like.

The optical information recording medium of the present invention comprises at least one azo metal complex dye in the form of a complex of at least one azo dye denoted by general formula (1) and at least one metal ion in the recording layer, and may comprise one, two, or more of the azo metal complex dye in the recording layer. The content of the azo metal complex dye in the recording layer can fall within a range of 1 to 100 weight percent, preferably falls within a range of 70 to 100 weight percent, more preferably falls within a range of 80 to 100 weight percent, and still more preferably, falls within a range of 90 to 100 weight percent of the total weight of the recording layer.

It suffices for the optical information recording medium of the present invention to have at least one recording layer comprising the azo metal complex dye in the form of a complex of at least one azo dye denoted by general formula (1) and at least one metal ion on the support (on a surface having pregrooves with a track pitch of 50 to 500 nm), but it may have two or more such recording layers. One or more recording layers other than recording layers comprising the above azo metal complex dye may also be present. When the recording layer comprising the above azo metal complex dye further comprises other recording dyes, the proportion of the azo metal complex dye to the total dye component is preferably 70 to 100 weight percent, more preferably 80 to 100 weight percent.

When employing dyes other than the above azo metal complex dye as dye components in the present invention, these dyes preferably have absorption in the short wavelength region of equal to or shorter than 440 nm, for example. Such dyes are not specifically limited; examples are azo dyes, azo metal complex dyes, phthalocyanine dyes, oxonol dyes, cyanine dyes, and squarylium dyes.

In the optical information recording medium of the present invention, the recording layer comprising the azo metal complex dye is a layer permitting the recording of information by irradiation of a laser beam. The phrase “permitting the recording of information by irradiation of a laser beam” means that the optical characteristics of portions of the recording layer that are irradiated with a laser beam change. The change in optical characteristics is thought to occur when a laser beam is directed onto the recording layer and the irradiated portions absorb the beam, causing the temperature to rise locally and producing a physical or chemical change (such as generating a pit). Reading (reproduction) of information that has been recorded on the recording layer can be achieved by irradiating a laser beam of the same wavelength as that employed in recording, for example, and detecting the difference in optical characteristics, such as the refractive index, between portions where the optical characteristics of the recording layer have been changed (recorded portions) and portions where they have not (unrecorded portions). The above-described azo metal complex dye absorbs laser beams of equal to or shorter than 440 nm, for example. The optical information recording medium of the present invention, which comprises a recording layer comprising the metal complex compound having absorption in the short wavelength region in this manner is suitable as a large-capacity optical disk permitting recording by a short-wavelength laser, such as an optical disk of the Blu-ray type that employs a blue laser of 405 nm. The method for recording and reproducing information on the optical information recording medium of the present invention will be described further below.

The optical information recording medium of the present invention comprises at least the above-described recording layer comprising the azo metal complex dye on a support, and may further comprise a light reflective layer, a protective layer, and the like in addition to the above-described recording layer.

Any of the various materials conventionally employed as support materials for optical information recording media may be selected for use as the support employed in the present invention. A transparent disk-shaped support is preferably employed as the support.

Specific examples are glass, acrylic resins such as polycarbonate and polymethyl methacrylate, vinyl chloride resins such as polyvinyl chloride and vinyl chloride copolymers, epoxy resins, amorphous polyolefins, polyesters, and metals such as aluminum. They may be employed in combination as desired.

Of the above materials, thermoplastic resins such as amorphous polyolefins and polycarbonates are preferable, and polycarbonates are particularly preferable, from the perspectives of resistance to humidity, dimensional stability, low cost, and the like. When employing these resins, the support can be manufactured by injection molding.

The thickness of the support generally falls within a range of 0.7 to 2 mm, preferably a range of 0.9 to 1.6 mm, and more preferably, within a range of 1.0 to 1.3 mm.

To enhance smoothness and increase adhesive strength, an undercoating layer can be formed on the surface of the support on the side on which the light reflective layer, described further below, is positioned.

Tracking guide grooves or irregularities (pregrooves) denoting information such as address signals are formed on the surface of the support on which the recording layer is formed. The track pitch of these pregrooves falls within a range of 50 to 500 nm. When the track pitch is equal to or greater than 50 nm, not only is it possible to correctly form the pregrooves, but the generation of crosstalk can be avoided. At equal to or less than 500 nm, high-density recording is possible. A support on which a narrower track pitch than that employed in CD-Rs and DVD-Rs is formed to achieve a higher recording density is employed in the optical information recording medium of the present invention. The preferable range of the track pitch will be described in detail further below.

An optical information recording medium (referred to as “Embodiment (1)” hereinafter) sequentially comprising, from the support side, a support 0.7 to 2 mm in thickness, a dye-containing recordable layer, and a cover layer 0.01 to 0.5 mm in thickness is an example of a preferable embodiment of the optical information recording medium of the present invention.

In Embodiment (1), it is preferable for the pregrooves formed on the support to be 50 to 500 nm in the track pitch, 25 to 250 nm in the groove width, and 5 to 150 nm in the groove depth.

Optical information recording medium of Embodiment (1) will be described in detail below. However, the present invention is not limited to Embodiment (1).

### Optical Information Recording Medium of Embodiment (1)

The optical information recording medium of Embodiment (1) comprises at least a support, a recordable recording layer, and a cover layer. The optical information recording medium of Embodiment (1) is suitable as a Blu-ray type recording medium. In the Blu-ray system, information is recorded and reproduced by irradiation of a laser beam from the cover layer side, and a light reflective layer is normally provided between the support and the recording layer. Therefore, the laser beam is irradiated onto the recording layer from an opposite surface side, the opposite surface being opposite from the support.

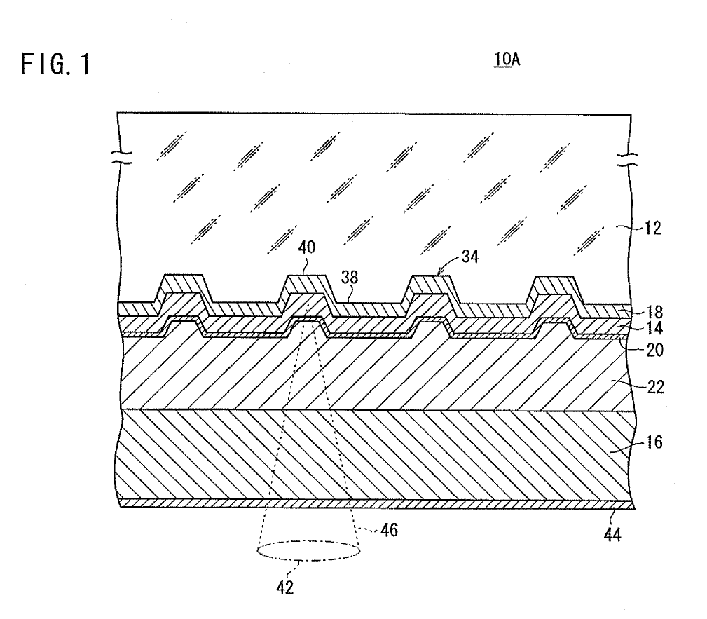

FIG. 1 shows an example of an optical information recording medium of Embodiment (1). The first optical information recording medium 10A shown in FIG. 1 is comprised of first light reflective layer 18, first recordable layer 14, barrier layer 20, first bonding layer or first adhesive layer 22, and cover layer 16, in that order on first support 12

These materials constituting these components will be sequentially described below.

### Support

On the support of Embodiment (1) are formed pregrooves (guide grooves) having a shape such that the track pitch, groove width (half width), groove depth, and wobble amplitude all fall within the ranges given below. The pregrooves are provided to achieve a recording density greater than that of CD-Rs and DVD-Rs. For example, the optical information recording medium of the present invention is suited to use as a medium for blue-violet lasers.

The track pitch of the pregrooves ranges from 50 to 500 nm. When the track pitch is equal to or greater than 50 nm, not only is it possible to correctly form the pregrooves, but the generation of crosstalk can be avoided. At equal to or less than 500 nm, high-density recording is possible. The rack pitch of the pregrooves is preferably ranges from 100 nm to 420 nm, more preferably from 200 nm to 370 nm, and further preferably from 260 nm to 330 nm.

The groove width (half width) of the pregrooves ranges from 25 to 250 nm, preferably from 50 to 240 nm, more preferably from 80 to 230 nm, and further preferably from 100 to 220 nm. A pregroove width of equal to or higher than 25 nm can permit adequate transfer of the grooves during molding and can inhibit a rise in the error rate during recording. A groove width of equal to or lower than 250 nm can also permit adequate transfer of grooves during molding and can avoid crosstalk due to the widening of bits formed during recording.

The groove depth of the pregrooves ranges from 5 to 150 nm. Pregrooves that are equal to or greater 5 nm in depth can permit an adequate degree of recording modulation, and a depth of equal to or less than 150 nm can permit the achieving of high reflectance. The groove depth of the pregrooves preferably ranges from 10 to 85 nm, more preferably from 20 to 80 nm, and further preferably from 28 to 75 nm.

The upper limit of the groove tilt angle of the pregrooves is preferably equal to or less than 80°, more preferably equal to or less than 75°, further preferably equal to or less than 70°, and still more preferably, equal to or less than 65°. The lower limit is preferably equal to or greater than 20°, more preferably equal to or greater than 30°, and still more preferably, equal to or greater than 40°.

When the groove tilt angle of the pregrooves is equal to or greater than 20°, an adequate tracking error signal amplitude can be achieved, and at equal to or less than 80°, shaping properties are good.

### Recordable Recording Layer

The recordable recording layer of Embodiment (1) can be formed by preparing a coating liquid by dissolving the dye in a suitable solvent with or without the use of a binder or the like, coating this coating liquid on the support or on a light reflective layer, described further below, to form a coating, and then drying the coating. The recordable recording layer may comprise a single layer or multiple layers. When the structure is multilayer, the step of coating the coating liquid may be conducted multiple times.

The concentration of dye in the coating liquid generally ranges from 0.01 to 15 weight percent, preferably ranges from 0.1 to 10 weight percent, more preferably ranges from 0.5 to 5 weight percent, and still more preferably, ranges from 0.5 to 3 weight percent.

Examples of the solvent employed in preparing the coating liquid are: esters such as butyl acetate, ethyl lactate, and Cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, and n-butanol diacetone alcohol; fluorine solvents such as 2,2,3,3-tetrafluoro-1-propanol; and glycol ethers such as ethylene glycol monomethylether, ethylene glycol monoethylether, and propylene glycol monomethylether.

The solvents may be employed singly or in combinations of two or more in consideration of the solubility of the dyes employed. Binders, oxidation inhibitors, UV absorbing agents, plasticizers, lubricants, and various other additives may be added to the coating liquid as needed.

Examples of coating methods are spraying, spincoating, dipping, roll coating, blade coating, doctor roll coating, and screen printing.

During coating, the temperature of the coating liquid preferably falls within a range of 23 to 50° C., more preferably within a range of 24 to 40° C., and further preferably, within a range of 23 to 50° C.

The thickness of the recordable recording layer on lands (protrusions on the support) is preferably equal to or less than 300 nm, more preferably equal to or less than 250 nm, further preferably equal to or less than 200 nm, and still more preferably, equal to or less than 180 nm. The lower limit is preferably equal to or greater than 1 nm, more preferably equal to or greater than 3 nm, further preferably equal to or greater than 5 nm, and still more preferably, equal to or greater than 7 nm.

The thickness of the recordable recording layer on grooves (indentation in the support) is preferably equal to or less than 400 nm, more preferably equal to or less than 300 nm, and further preferably, equal to or less than 250 nm. The lower limit is preferably equal to or greater than 10 nm, more preferably equal to or greater than 20 nm, and further preferably, equal to or greater than 25 nm.

The ratio of the thickness of the recordable recording layer on lands to the thickness of the recordable recording layer on grooves (thickness on lands/thickness on grooves) is preferably equal to or greater than 1.0, more preferably equal to or greater than 0.13, further preferably equal to or greater than 0.15, and still more preferably, equal to or greater than 0.17. The upper limit is preferably less than 1, more preferably equal to or less than 0.9, further preferably equal to or less than 0.85. and still more preferably, equal to or less than 0.8.

Various antifading agents may be incorporated into the recordable recording layer to enhance the resistance to light of the recordable recording layer. Singlet oxygen quenchers are normally employed as the antifading agent. The single oxygen quencher can also be employed in the present invention to further enhance the resistance to light. Singlet oxygen quenchers that are described in known publications such as patent specifications may be employed.

Specific examples are described in Japanese Unexamined Patent Publication (KOKAI) Showa Nos. 58-175693, 59-81194, 60-18387, 60-19586, 60-19587, 60-35054, 60-36190, 60-36191, 60-44554, 60-44555, 60-44389, 60-44390, 60-54892, 60-47069, and 63-209995; Japanese Unexamined Patent Publication (KOKAI) Heisei No. 4-25492; Japanese Examined Patent Publication (KOKOKU) Heisei Nos. 1-38680 and 6-26028; German Patent No. 350399; and the Journal of the Japanese Chemical Society, October Issue, 1992, p. 1141, which are expressly incorporated herein by reference in their entirety.

The quantity of antifading agent in the form of the above singlet oxygen quencher or the like normally falls within a range of 0.1 to 50 weight percent, preferably falls within a range of 0.5 to 45 weight percent, more preferably falls within a range of 3 to 40 weight percent, and still more preferably, falls within a range of 5 to 25 weight percent, of the quantity of dye.

### Cover Layer

The cover layer in Embodiment (1) is normally adhered through a bonding agent or adhesive onto the above-described recordable recording layer or onto a barrier layer such as that shown in FIG. 1.

The cover layer is not specifically limited, other than that it be a film of transparent material. An acrylic resin such as a polycarbonate or polymethyl methacrylate; a vinyl chloride resin such as polyvinyl chloride or a vinyl chloride copolymer; an epoxy resin; amorphous polyolefin; polyester; or cellulose triacetate is preferably employed. Of these, the use of polycarbonate or cellulose triacetate is more preferable.

The term “transparent” means having a transmittance of equal to or greater than 80 percent for the beam used in recording and reproducing.

The cover layer may further contain various additives so long as they do not compromise the effect of the present invention. For example, UV-absorbing agents may be incorporated to cut light with the wavelength of equal to or shorter than 400 nm and/or dyes may be incorporated to cut light with the wavelength of equal to or longer than 500 nm.

As for the physical surface properties of the cover layer, both the two-dimensional roughness parameter and three-dimensional roughness parameter are preferably equal to or less than 5 nm.

From the perspective of the degree of convergence of the beam employed in recording and reproducing, the birefringence of the cover layer is preferably equal to or lower than 10 nm.

The thickness of the cover layer can be suitably determined based on the NA or wavelength of the laser beam irradiated in recording and reproducing. In the present invention, the thickness preferably falls within a range of 0.01 to 0.5 mm, more preferably a range of 0.05 to 0.12 mm.

The total thickness of the cover layer and bonding or adhesive layer is preferably 0.09 to 0.11 mm, more preferably 0.095 to 0.105 mm.

A protective layer (hard coating layer 44 in the embodiment shown in FIG. 1) may be provided on the incident light surface of the cover layer during manufacturing of the optical information recording medium to prevent scratching of the incident light surface.

To bond the cover layer and the recordable recording layer or barrier layer, a bonding layer or an adhesive layer may be provided between the two layers.

A UV-curable resin, EB-curable resin, thermosetting resin, or the like is preferably employed as the bond in the bonding layer.

When employing a UV-curable resin as the bond, the UV-curable resin may be employed as is, or dissolved in a suitable solvent such as methyl ethyl ketone or ethyl acetate to prepare a coating liquid, which is then coated on the surface of the barrier layer with a dispenser. To prevent warping of the optical information recording medium that has been manufactured, a UV-curable resin having a low curing shrinkage rate is preferably employed in the bonding layer. Examples of such UV-curable resins are SD-640 and the like, made by Dainippon Ink and Chemicals, Inc.

The method of forming the bonding layer is not specifically limited. It is desirable to coat a prescribed quantity of bond on the surface of the barrier layer or the recordable layer (the bonded surface), dispose a cover layer thereover, uniformly spread the bond between the bonded surface and the cover layer by spin-coating or the like, and then cure the bond.

The thickness of the bonding layer preferably falls within a range of 0.1 to 100 micrometers, more preferably a range of 0.5 to 50 micrometers, and further preferably, 1 to 30 micrometers.

Examples of the adhesive employed in the adhesive layer are acrylic, rubber, and silicone adhesives. From the perspectives of transparency and durability, acrylic adhesives are preferable. Preferable acrylic adhesive is an acrylic adhesive comprising a main component in the form of 2-ethylhexyl acrylate, n-butyl acrylate, or the like copolymerized with a short-chain alkyl acrylate or methacrylate, such as methyl acrylate, ethyl acrylate, or methyl methacrylate to increase the cohesive force, and the component capable of becoming a crosslinking point with a crosslinking agent, such as acrylic acid, methacrylic acid, an acrylamide derivative, maleic acid, hydroxylethyl acrylate, or glycidyl acrylate. The type and blending ratio of the main component, short-chain component, and component for the addition of a crosslinking point can be suitably adjusted to vary the glass transition temperature (Tg) and crosslinking density. The glass transition temperature (Tg) preferably equal to or less than 0° C., more preferably equal to or less than −15° C., and further preferably, equal to or less than −25° C.

The glass transition temperature (Tg) can be measured by differential scanning calorimetry (DSC) with a DSC6200R made by Seiko Instruments, Inc.

The method described in Japanese Unexamined Patent Publication (KOKAI) No. 2003-217177, Japanese Unexamined Patent Publication (KOKAI) No. 2003-203387, Japanese Unexamined Patent Publication (KOKAI) Heisei No. 9-147418, which are expressly incorporated herein by reference in their entirety, or the like can be used to prepare the adhesive.

The method of forming the adhesive layer is not specifically limited. A prescribed quantity of adhesive can be uniformly coated on the surface of the barrier layer or recordable recording layer (the adhered surface), a cover layer can be disposed thereover, and the adhesive can be cured. Alternatively, a prescribed quantity of adhesive can be uniformly coated on one side of the cover layer to form a coating of adhesive, this coating can be adhered to the adhered surface, and then the adhesive can be cured.

Further, a commercial adhesive film on which an adhesive layer has been disposed in advance can be employed as the cover layer.

The thickness of the adhesive layer preferably falls within a range of 0.1 to 100 micrometers, more preferably a range of 0.5 to 50 micrometers, and further preferably, a range of 10 to 30 micrometers.

The cover layer can also be formed by spin-coating UV-curable resin.

### Other Layers

The optical information recording medium of Embodiment (1) may optionally comprise other layers in addition to the above-described essential layers so long as the effect of the present invention is not compromised. Examples of such optional layers are a label layer having a desired image that is formed on the back of the support (the reverse unformed side from the side on which the recordable recording layer is formed), a light reflective layer positioned between the support and the recordable recording layer (described in detail further below), a barrier layer positioned between the recordable recording layer and the cover layer (described in detail further below), and a boundary layer positioned between the above light reflective layer and the recordable recording layer. The “label layer” may be formed from UV-curing resin, thermosetting resin, or heat-drying resin.

Each of the above-described essential layers and optional layers may have a single-layer or multilayer structure.

To increase reflectance for the laser beam and impart functions that enhance recording and reproducing characteristics to the optical information recording medium of Embodiment (1), a light reflective layer is preferably formed between the support and the recordable recording layer.

The reflective layer can be formed, for example, by vacuum vapor depositing, by sputtering, or by ion plating a light reflective substance with high reflectance for the laser beam on the support. The thickness of the light reflective layer can normally range from 10 to 300 nm, preferably ranges from 30 to 200 nm.

The reflectance is preferably equal to or greater than 70 percent.

Examples of light reflective substances of high reflectance are: metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi; and stainless steel. These light reflective substances may be employed singly, in combinations of two or more, or as alloys. Of these, the preferable substances are: Cr, Ni, Pt, Cu, Ag, Au, Al, and stainless steel; the more preferable substances are: Au, Ag, Al, and their alloys; and the substances of greatest preference are: Au, Ag, and their alloys.

### Barrier Layer

In the optical information recording medium of Embodiment (1), as shown in FIG. 1, it is preferable to form a barrier layer between the recordable recording layer and the cover layer.

The barrier layer can be provided to enhance the storage properties of the recordable recording layer, enhance adhesion between the recordable recording layer and cover layer, adjust the reflectance, adjust thermal conductivity, and the like.

The material employed in the barrier layer is a material that passes the beam employed in recording and reproducing; it is not specifically limited beyond being able to perform this function. For example, it is generally desirable to employ a material with low permeability to gas and moisture. A material that is also a dielectric is preferred.

Specifically, materials in the form of nitrides, oxides, carbides, and sulfides of Zn, Si, Ti, Te, Sn, Mo, Ge, Nb, Ta and the like are preferable. MoO₂, GeO₂, TeO, SiO₂, TiO₂, ZuO, SnO₂, ZnO—Ga₂O₃, Nb₂O₅, and Ta₂O₅ are preferable and SnO₂, ZnO—Ga₂O₃, SiO₂, Nb₂O₅, and Ta₂O₅ are more preferable.

The barrier layer can be formed by vacuum film-forming methods such as vacuum vapor deposition, DC sputtering, RF sputtering, and ion plating. Of these, sputtering is preferred.

The thickness of the barrier layer preferably falls within a range of 1 to 200 nm, more preferably within a range of 2 to 100 nm, and further preferably, within a range of 3 to 50 nm.

### Method of Recording and Reproducing Information

The present invention further relates to a method of recording and reproducing information. The method comprises recording information on the recording layer comprised in the optical recording medium of the present invention and reproducing the information, and conducting the recording and reproducing by irradiation of a laser beam having a wavelength of equal to or shorter than 440 nm onto the optical information recording medium.

By way of example, information is recorded on the above-described preferred optical information recording medium of Embodiment (1) in the following manner.

First, while rotating an optical information recording medium at a certain linear speed (such as 0.5 to 10 m/s) or a certain angular speed, a laser beam for recording, such as a semiconductor laser beam, is directed from the protective layer side. Irradiation by this laser beam changes the optical properties of the portions that are irradiated, thereby recording information. In the embodiment shown in FIG. 1, recording laser beam 46 such as a semiconductor laser beam is directed from cover layer 16 side through first object lens 42 (having a numerical aperture NA of 0.85, for example). Irradiation by laser beam 46 causes recordable recording layer 14 to absorb laser beam 46, resulting in a local rise in temperature. This is thought to produce a physical or chemical change (such as generating pits), thereby altering the optical characteristics and recording information.

In the method of recording and reproducing information of the present invention, information is recorded by irradiation of a laser beam having a wavelength of equal to or shorter than 440 nm. A semiconductor laser beam having an oscillation wavelength falling within a range of equal to or shorter than 440 nm is suitable for use as a recording beam. A blue-violet semiconductor laser beam having an oscillation wavelength falling within a range of 390 to 415 nm and a blue-violet SHG laser beam having a core oscillation wavelength of 425 nm obtained by halving the wavelength of an infrared semiconductor laser beam having a core oscillation wavelength of 850 nm with an optical waveguide device are examples of preferable light sources. In particular, a blue-violet semiconductor laser beam having an oscillation wavelength of 390 to 415 nm is preferably employed from the perspective of recording density. The information that is thus recorded can be reproduced by directing the semiconductor laser beam from the support side or protective layer side while rotating the optical information recording medium at the same constant linear speed as in the recording, and detecting the reflected beam.

### AZO Metal Complex Dye

The present invention further relates to:

an azo metal complex dye that is a complex of at least one azo dye denoted by general formula (3) above and at least one metal ion;

an azo metal complex dye that is a complex of at least one azo dye denoted by general formula (4) above and at least one metal ion;

an azo metal complex dye that is a complex of at least one azo dye denoted by general formula (5) above and at least one metal ion; and

an azo metal complex dye that is a complex of at least one azo dye denoted by general formula (6) above and at least one metal ion.

The azo metal complex dye of the present invention can be employed in various uses, such as colorants, photographic materials, UV-absorbing materials, color filter dyes, and color-changing filters. The azo metal complex dye of the present invention can afford good characteristics in optical information recording, particularly recording by irradiation with a short-wavelength laser beam. They also can afford good light resistance and storage stability in solution. Thus, they are desirably employed as a recording layer dye in an optical information recording medium having a dye-containing recording layer. The details of the azo metal complex dye of the present invention, and methods for manufacturing the dye, are as set forth above.

### EXAMPLES

The present invention will be described in detail below based on examples. However, the present invention is not limited to the examples.

### Synthesis of Compound (D-1)

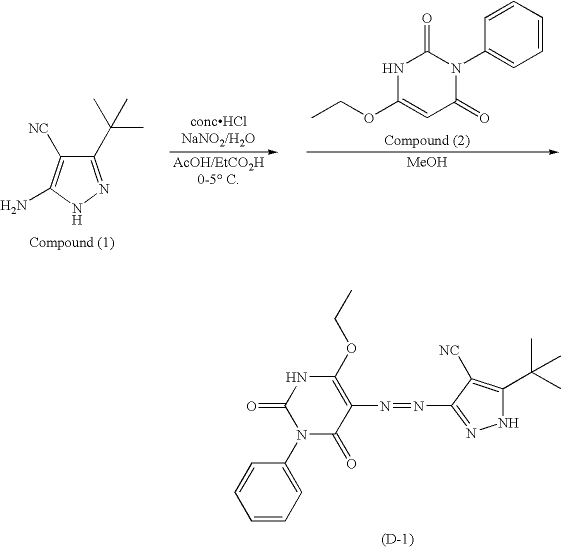

To 2.0 g of compound (1) were added 4 mL of acetic acid and 8 mL of propionic acid to form a suspension. A 3 mL quantity of hydrochloric acid (35 to 37 percent) was gradually added dropwise, dissolving the suspension. The solution was cooled to 0 to 5° C. in an ice bath. A solution of 0.69 g of sodium nitrite dissolved in 5 mL of water (cooled to equal to or lower than 5° C.) was gradually added dropwise, after which the mixture was stirred for 1 hour at 0 to 5° C. This acid solution was gradually added to a suspension of 2.82 g of compound (2) in 30 mL of methanol maintained at 0 to 5° C. with ice cooling, and the mixture was stirred for 1 hour. Following stirring for 2 hours at equal to or lower than 10° C., 30 mL of water was added. The precipitate was filtered out and washed with water followed by methanol. The solid obtained was dried, yielding 2.43 g of compound (D-1). The compound was identified by 300 MHz ¹H-NMR.

H-NMR (dmso-d⁶) [ppm]; δ13.6(1H,br), 7.46(3H,m), 7.29(2H,m), 4.46(2H,q), 1.40(12H,m)

### Synthesis of Compound (D-5)

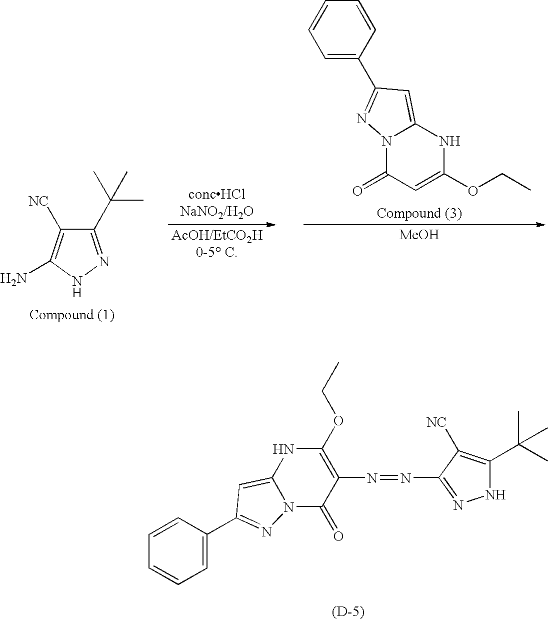

To 3.3 g of compound (1) were added 6 mL of acetic acid and 12 mL of propionic acid to form a suspension. A 5 mL quantity of hydrochloric acid (35 to 37 percent) was gradually added dropwise, dissolving the suspension. The solution was cooled to 0 to 5° C. in an ice bath. A solution of 1.52 g of sodium nitrite dissolved in 5 mL of water (cooled to equal to or lower than 5° C.) was gradually added dropwise, after which the mixture was stirred for 1 hour at 0 to 5° C. This acid solution was gradually added to a suspension of 5.1 g of compound (3) in 20 mL of methanol maintained at 0 to 5° C. with ice cooling, and the mixture was stirred for 1 hour. Following stirring for 2 hours at equal to or lower than 10° C., 30 mL of water was added. The precipitate was filtered out and washed with water followed by methanol. The solid obtained was dried, yielding 3.5 g of compound (D-5). The compound was identified by 300 MHz ¹H-NMR.

¹H-NMR(dmso-d⁶) [ppm]; δ13.6(1H,br), 7.97(2H,m), 7.48(3H,m), 6.92(1H,s), 4.40 (2H,q), 1.45(9H,s), 1.39(3H,t)

(D-6), (D-8), (D-10), (D-15), and (E-3) were synthesized by the same method as that used to synthesize compounds (D-1) and (D-5) above. The various azo dyes described by the present invention can be similarly synthesized. The compounds were identified by 300 MHz ¹H-NMR. The NMR spectral data are given below.

(D-6) ¹H-NMR(CDCl₃)[ppm]; δ6.15 (1H,s), 4.50(2H,q), 1.58(9H,s), 1.55(3H,t), 1.35(9H,s)

(D-8) ¹H-NMR(dmso-d⁶)[ppm]; δ14.14(1H,s), 13.43(1H,s), 7.82(2H,m), 7.50(3H,m), 4.43(2H,q), 2.23(3H,s), 1.43(9H,s), 1.39(3H,t)

(D-10) ¹H-NMR(dmso-d⁶)[ppm]; δ13.5(1H,br), 8.21(1H,s), 4.50(2H,q), 4.24(2H,q), 1.44(12H,m), 1.39(3H,t)

(D-15) ¹H-NMR(CDCl₃)[ppm]; δ7.71(2H,m), 7.43(3H,m), 4.52(2H,q), 2.75(3H,s), 1.42(9H,s), 1.28(3H,t)

(E-3) ¹H-NMR(dmso-d⁶)[ppm]; δ7.97(2H,m), 7.48(3H,m), 6.92(1H,s), 6.50(1H,s), 4.40(2H,q), 2.45(3H,s), 1.39(3H,t)

The specific examples of the method of synthesizing the azo metal complex dye of the present invention will be described below. However, the present invention is not limited to these methods.

### Synthesis of Compound (M-5)

A 1.3 g quantity of Compound (D-5) was added to 15 mL of methanol, and then dissolved by the addition of 1.52 g of triethylamine while stirring. To this solution was added 680 mg of Cu(OAc)₂.H₂O and the mixture was hot refluxed for 3 hours. The mixture was returned to room temperature, 30 mL of distilled water was added, and the precipitate was filtered out. The precipitate was washed with distilled water and dried, yielding 1.48 g of Compound (M-5). An amorphous film of Compound (M-5) was prepared by spin coating. The amorphous film exhibited absorption λmax of 477 nm, the refractive index n at 405 nm of 1.51, and the extinction coefficient k at 405 nm of 0.24.

(M-1), (M-6), (M-8), (M-9), (M-10), and (M-15) were synthesized by the same method as (M-5).

### Synthesis of Compound (M-11)

Cu(OAc)₂.H₂O was replaced with Co(OAc)₂.4H₂O in the synthesis method of Example Compound (M-5) and the same reaction was conducted to synthesize Compound (M-11).

(D-5) was replaced with (E-3) in the synthesis method of Compound (M-11) and the same reaction was conducted to synthesize Compound (M-22).

### Synthesis of Compound (M-12)

Cu(OAc)₂.H₂O was replaced with Ni(OAc)₂.4H₂O in the synthesis method of Example Compound (M-11) and the same reaction was conducted to synthesize Compound (M-12).

(D-5) was replaced with (E-3) in the synthesis method of Compound (M-12) and the same reaction was conducted to synthesize Compound (M-21).

Various azo metal complex dyes described by the present invention can be synthesized by the same methods as those used to synthesize compounds (M-5), (M-11), and (M-12) set forth above.

### Examples 1 to 11

### Preparation of Optical Information Recording Medium

### (Preparation of Support)

An injection molded support comprised of polycarbonate resin and having a thickness of 1.1 mm, an outer diameter of 120 mm, an inner diameter of 15 mm, and spiral pregrooves (with a track pitch of 320 nm, a groove width (at concave portion) of 190 nm, a groove depth of 47 nm, a groove tilt angle of 65°, and a wobble amplitude of 20 nm) was prepared. Mastering of the stamper employed during injection-molding was conducted by laser beam (351 nm) cutting.

### (Formation of Light Reflective Layer)

An ANC (Ag: 98.1 at %, Nd: 0.7 at %, Cu: 0.9 at %) light reflective layer 60 nm in thickness was formed on the support as a vacuum-formed film layer by DC sputtering in an Ar atmosphere using a Cube manufactured by Unaxis Corp. The thickness of the light reflective film was adjusted by means of the duration of sputtering.

### (Formation of Recordable Recording Layer)

A one gram of each of compounds described in Table 2 was separately added to and dissolved in 100 mL of 2,2,3,3-tetrafluoropropanol and dye-containing coating liquids were prepared as Examples 1 to 11. The dye-containing coating liquids that had been prepared were then coated on a first reflective layer 18 by spin coating while varying the rotational speed from 500 to 2,200 rpm under conditions of 23° C. and 50 percent RH to form a first recordable recording layer 14.

After forming the recordable recording layer, annealing was conducted in a clean oven. In the annealing process, the supports were supported while creating a gap with spacers in the vertical stack pole and maintained for 1 hour at 80° C.

### (Formation of Barrier Layer)

Subsequently, a Cube made by Unaxis Corp. was employed to form by DC sputtering in an argon atmosphere a barrier layer comprised of Nb₂O₅ having a thickness of 10 nm on the recordable recording layer.

### (Adhesion of a Cover Layer)

A cover layer in the form of a polycarbonate film (Teijin Pureace, 80 micrometers in thickness) measuring 15 mm in inner diameter, 120 mm in outer diameter, and having an adhesive layer (with a glass transition temperature of −52° C.) on one side was provided so that the combined thickness of the adhesive layer and the polycarbonate film was 100 micrometers.

After placing the cover layer on the barrier layer through the adhesive layer, a member was placed against the cover layer and pressure was applied, bonding the cover layer and barrier layer. This process yielded an optical information recording medium having the layer structure shown in FIG. 1.

The optical information recording media of Examples 1 to 11 were thus prepared.

### <Measurement of the Film Thickness of the Dye Layer>

Cross-sections of the optical information recording media obtained were viewed by SEM and the thickness of the dye layer respectively at the groove concave portion and the groove convex portion were read. The groove concave portion of the dye layer was +0 to 10 nm in depth, and the groove convex portion of the dye layer was about 10 to 30 nm.

### Comparative Examples 1 to 4

### Preparation of Optical Information Recording Medium

With the exception that Comparative compounds (A) to (D) were employed in place of the Example Compound as dyes in the recordable recording layer, the optical information recording media of Comparative Examples 1 to 4 were prepared by the same method as in Examples.

Comparative compound (A): compound within the scope described in Japanese Unexamined Patent Publication (KOKAI) No. 2007-45147

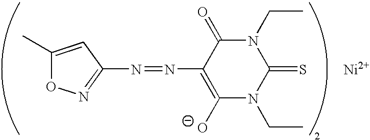

Comparative compound (B): compound described in Japanese Unexamined Patent Publication (KOKAI) No. 2006-306070

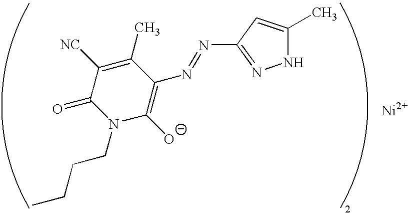

Comparative compound (C): compound described in Japanese Unexamined Patent Publication (KOKAI) No. 2000-168237

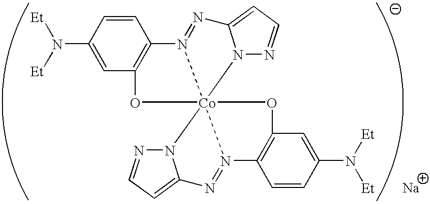

Comparative compound (D): compound described in Japanese Unexamined Patent Publication (KOKAI) No. 2007-26541

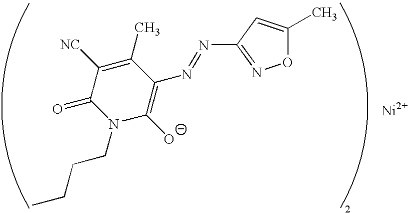

### <Evaluation of Optical Information Recording Media>

### 1. Evaluation of C/N (Carrier/Noise Ratio)

A 0.16 micrometer signal (2T) was recorded on and reproduced from the prepared optical information recording media at a clock frequency of 66 MHz and a linear speed of 4.92 m/s with an apparatus for evaluating recorded and reproduced information (DDU1000 made by Pulstech Corp.) equipped with a 403 nm laser and an NA 0.85 pickup, and the output was measured with a spectral analyzer (FSP-3 made by Rohde-Schwarz). Peak output observed in the vicinity of 16 MHz following recording was adopted as the carrier output, and the output at the same frequency before recording was adopted as the noise output. The output following recording minus the output prior to recording was taken as the C/N value. Recording was conducted on grooves. The laser beam for recording and reproduction was irradiated from the cover layer side. The recording power was 4 to 7 mW and the reproducing power was 0.3 mW. The results are shown in Table 2. A C/N ratio (following recording) of equal to or greater than 30 dB at 7 mW was considered adequate for both recording sensitivity and reproduction signal intensity, indicating good recording and reproduction characteristics.

### 2. Evaluation of the Light Resistance of the Dye Film

Dye-containing coating liquids identical to Examples 1 to 11 and Comparative Examples 1 to 4 were prepared and applied at 23° C. and 50% RH to glass sheets 1.1 mm in thickness by spincoating while varying the rotational speed from 500 to 1,000 rpm. Subsequently, the glass sheets were maintained for 24 hours at 23° C. and 50% RH. A merry-go-round shaped light resistance tester (Cell Tester III, made by Eagle Engineering, Inc., with WG320 filter made by Schott) was then used to conduct a light resistance test. The absorption spectra of the dye film immediately prior to the light resistance test and 48 hours after the light resistance test were measured with a UV-1600PC (made by Shimadzu Corp.). The change in absorbance at the maximum absorption wavelength was read.

TABLE 2

| | | | Recording and |
|---|---|---|---|
| | | | reproduction |
| | | | characteristics |
| | Azo metal | Light resistance | (2T recording |
| | complex dye | of dye film^{(Note 1)} | C/N)^{(Note 2)} |
| Ex. 1 | (M-5) | ◯ | ◯ |
| Ex. 2 | (M-6) | ◯ | ◯ |
| Ex. 3 | (M-8) | ◯ | ◯ |
| Ex. 4 | (M-9) | ◯ | ◯ |
| Ex. 5 | (M-10) | ◯ | ◯ |
| Ex. 6 | (M-1) | ◯ | ◯ |
| Ex. 7 | (M-11) | ◯ | ◯ |
| Ex. 8 | (M-12) | ◯ | ◯ |
| Ex. 9 | (M-15) | ◯ | ◯ |
| Ex. 10 | (M-21) | ◯ | ◯ |
| Ex. 11 | (M-22) | ◯ | ◯ |
| Comp. Ex. 1 | Comp. Compound | Δ | ◯ |
| | (A) | | |
| Comp. Ex. 2 | Comp. Compound | — | X^{(Note 3)} |
| | (B) | (Not dissolved) | |
| Comp. Ex. 3 | Comp. Compound | Δ | X |
| | (C) | | |
| Comp. Ex. 4 | Comp. Compound | X | ⊚ |
| | (D) | | |

^{(Note 1)}After 48 hours of irradiation by Xe lamp, a dye remaining rate at absorption λmax of equal to or greater than 80 percent was denoted by ◯, equal to or greater than 70 percent but less than 80 percent by Δ, and less than 70 percent by X.
^{(Note 2)}2T recording C/N of equal to or greater than 35 dB was denoted by ⊚, equal to or greater than 30 dB but less than 35 dB by ◯, and less than 30 dB by X.
^{(Note 3)}Due to poor solubility and the inability to form an adequate recording layer, recording or measurement was precluded.

As shown in Table 2, in contrast to Comparative Examples 1 to 4, in which conventional azo metal complexes were employed, each of Examples 1 to 11 achieved both light resistance and recording and reproduction characteristics, and exhibited good characteristics as dyes for Blu-ray disks.

The azo metal complex dye employed in Examples afforded good solubility in the coating solvent as well as good film stability.

### <Evaluation of the Light Resistance of the Dye Solution>

Each of the azo metal complex dyes employed in Examples was dissolved in 2,2,3,3-tetrafluoropropanol to an absorbance of 0.95 to 1.05 (cell width 1 cm), and light resistance was evaluated under the same conditions as in the evaluation of the light resistance of the dye films. As a result, each of the dye solutions exhibited an extremely high light resistance that was equivalent or better to that of the dye films. Light resistance is an important property that is required of dyes in a variety of applications. The azo metal complex dye employed in Examples, with their good light resistance in both film and solution states, were found to exhibit desirable properties in a variety of applications, such as ink, color filters, color-changing filters, photographic materials, and thermal transfer recording materials.

The optical information recording medium and azo metal complex dye according to the present invention are not limited to the above-described modes of implementation; various configurational modification is possible without departing from the scope or spirit of the present invention.

The optical information recording medium of the present invention is suitable as an optical disk for short-wavelength lasers, such as Blu-ray disks.

Employing the azo metal complex dye of the present invention as recording layer dye permits the manufacturing of optical information recording media exhibiting good recording and reproduction characteristics and having extremely good light resistance (particularly optical information recording media permitting the recording of information by irradiation with a laser beam with a wavelength of equal to or shorter than 440 nm).

Further, the azo metal complex dye of the present invention is applicable to photographic materials, color filter dyes, color converting filters, thermal transfer recording materials, inks, and the like.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An optical information recording medium comprising a recording layer on a surface of a support, wherein
the surface of the support has pregrooves with a track pitch ranging from 50 to 500 nm,
the recording layer comprises an azo metal complex dye in the form of a complex of at least one azo dye denoted by general formula (1) and at least one metal ion: 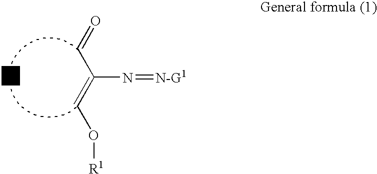
wherein, in general formula (1), Q¹ denotes an atom group forming a ring with two adjacent carbon atoms and a carbon atom bonded to —N═N-group, G¹ denotes a heterocyclic group or carbocyclic group, and R¹ denotes an alkyl group, alkenyl group, alkynyl group, aryl group, or heterocyclic group.

2. The optical information recording medium according to claim 1, wherein, in general formula (1), G¹ denotes the following partial structure: 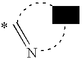
wherein, in the above partial structure, * denotes a binding position with —N═N-group, and Q² denotes an atom group forming a nitrogen-containing heterocyclic ring with an adjacent carbon atom and nitrogen atom.

3. The optical information recording medium according to claim 1, wherein the ring formed by Q¹ with the two adjacent carbon atoms and the carbon atom bonded to —N═N-group is a six-membered ring or a condensed ring structure obtained by condensing a six-membered ring.

4. The optical information recording medium according to claim 1, wherein, in general formula (1), the following partial structure: 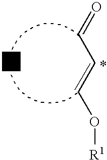
denotes one of the following partial structures (C-1) to (C-4): 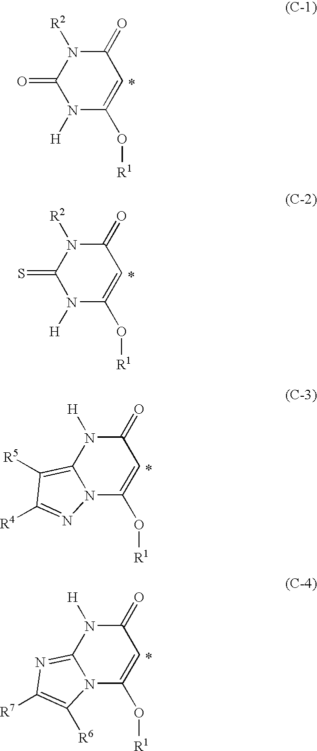
wherein, in the above partial structures, * denotes a binding position with —N═N-group, R¹ is defined as in general formula (1), R² denotes a hydrogen atom, alkyl group, alkenyl group, alkynyl group, aryl group, or heterocyclic group, each of R⁴ to R⁷ independently denotes a hydrogen atom or substituent, and adjacent substituents may bond together to form a ring.

5. The optical information recording medium according to claim 1, wherein, in general formula (1), G¹ denotes a pyrazole ring, imidazole ring, isooxazole ring, 1,3,4-thiadiazole ring, 1,2,4-thiadiazole ring, or triazole ring.

6. The optical information recording medium according to claim 4, wherein the azo dye denoted by general formula (1) is an azo dye denoted by general formula (3), (4), (5), or (6): 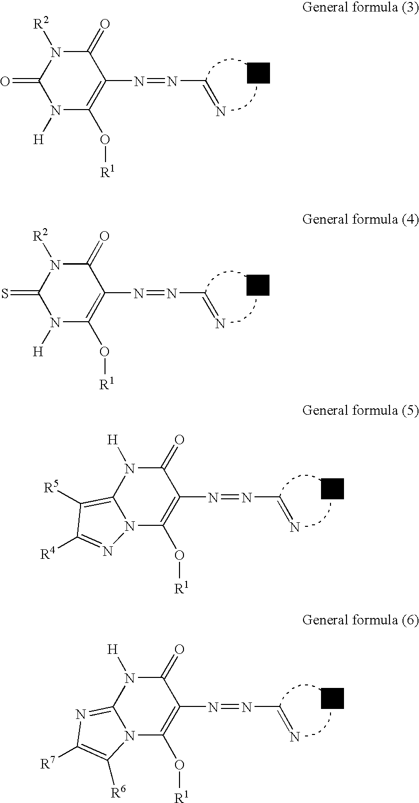
wherein, in general formulas (3), (4), (5), and (6), Q³ denotes an atom group forming a pyrazole ring, imidazole ring, isooxazole ring, 1,3,4-thiadiazole ring, or triazole ring with an adjacent carbon atom and nitrogen atom, R¹ is defined as in general formula (1), and R² and R⁴ to R⁷ are defined respectively as in (C-1) to (C-4).

7. The optical information recording medium according to claim 1, wherein the metal ion is a transition metal ion.

8. The optical information recording medium according to claim 7, wherein the transition metal is Mn, Fe, Co, Ni, Cu, or Zn.

9. The optical information recording medium according to claim 7, wherein the transition metal is Co, Ni, or Cu.

10. The optical information recording medium according to claim 7, wherein the transition metal is Cu.

11. The optical information recording medium according to claim 1, wherein information is recorded by irradiation of a laser beam having a wavelength of equal to or shorter than 440 nm.

12. The optical information recording medium according to claim 11, further comprising a reflective layer between the support and the recording layer, wherein the laser beam is irradiated onto the recording layer from an opposite surface side, the opposite surface being opposite from the support.

13. A method of recording and reproducing information comprising:
recording information on the recording layer comprised in the optical recording medium according to claim 1 and reproducing the information, and
conducting the recording and reproducing by irradiation of a laser beam having a wavelength of equal to or shorter than 440 nm onto the optical information recording medium.

14. An azo metal complex dye being a complex of at least one azo dye denoted by general formula (3), (4), (5), or (6) and at least one metal ion: 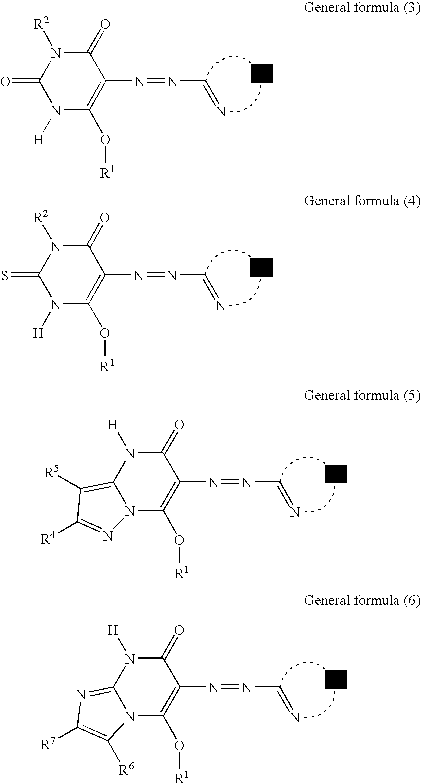
wherein, in general formulas (3), (4), (5), and (6), Q³ denotes an atom group forming a pyrazole ring, imidazole ring, isooxazole ring, 1,3,4-thiadiazole ring, or triazole ring with an adjacent carbon atom and nitrogen atom, R¹ denotes an alkyl group, alkenyl group, alkynyl group, aryl group, or heterocyclic group, R² denotes a hydrogen atom, alkyl group, alkenyl group, alkynyl group, aryl group, or heterocyclic group, each of R⁴ to R⁷ independently denotes a hydrogen atom or substituent, and adjacent substituents may bond together to form a ring.

15. The azo metal complex dye according to claim 14, wherein the metal ion is a transition metal ion.

16. The azo metal complex dye according to claim 15, wherein the transition metal is Mn, Fe, Co, Ni, Cu, or Zn.

17. The azo metal complex dye according to claim 15, wherein the transition metal is Co, Ni, or Cu.

18. The azo metal complex dye according to claim 15, wherein the transition metal is Cu.
